(19) United States
(12) Patent Application Publication
(10) Pub. No.: US 2018/0189527 A1
(43) Pub. Date: Jul. 5, 2018

(54) METHOD FOR ACTIVATING MULTI-FUNCTION DEVICE CARD

(71) Applicants: Soo Hyang Kang, Brea, CA (US); Nam Joo Kim, Seoul (KR)

(72) Inventor: Nam Joo KIM, Seoul (KR)

(21) Appl. No.: 15/605,808

(22) Filed: May 25, 2017

(30) Foreign Application Priority Data
Jan. 3, 2017 (KR) 10-2017-0000669

(51) Int. Cl. G06K 7/10; H04L 29/06

(52) U.S. Cl. CPC G06K 7/10297; H04L 63/08; G06K 7/10316

(57) ABSTRACT

A multi-function device card is activated by a personal electronic device. The method to activate the card includes connecting the personal electronic device to a NFC network, searching for the card through the NFC network, transmitting NFC signal to the card, connecting the personal electronic device to the card through a wireless personal area network, and mutually authenticating the personal electronic device and the card. The activation method includes additional steps to select a desired function of the multi-device card.

### CROSS-REFERENCE TO RELATED APPLICATIONS

This application claims priority to Korean patent application no. 10-2017-0000669 filed on Jan. 3, 2017, which is incorporate herein by reference.

### FIELD OF THE INVENTION

The present invention relates to a method for activating a multi-function device card, and, more particularly, to a method for activating a multi-function device card through an application installed on a personal electronic device utilizing near-field communication and a wireless personal area network.

### BACKGROUND OF THE INVENTION

Smart cards using an integrated circuit (IC) chip or a combination of an IC chip and a magnetic strip are classified into contact types and contactless types. Contactless smart cards can employ radio-frequency (RF) or near-field communication (NFC) to communicate with a compatible reader and have been used as credit cards, transportation passes, identification cards, membership cards, and the like.

Technological advances have also led to the creation of multi-function device (MFD) cards having writable internal memory. In addition to incorporating an IC chip, a magnetic strip, and means for contactless function, MFD cards may be capable of storing information of one or more standard cards. Such cards allow a user to carry the equivalent of multiple cards in a single physical card.

A method of issuing a credit card may be found in the first reference Korean Patent Application No. 19-2012-0092387 titled “Method for issuing mobile credit card in portable terminal using credit card and credit card for the same.” FIG. 18A, which is reproduced from the first reference, is a network diagram illustrating a relationship between a personal digital assistant (10), an IC card (20), and a card issue server (30). The personal digital assistant may read connection information about a site from which the card issue app can be downloaded using RFC from the IC card. The personal digital assistant then connects to the card issue server through an internet and downloads the card issue app based on the connection information read from the IC card. Alternatively, it may be possible to configure that the card issue app is downloaded from an app marketplace.

According to the first reference, when the downloaded card issue app is executed on the personal digital assistant, the card issue app may read encoded card information from the IC card using NFC and decode the password of the encoded card information, thus connecting to the card issue server to transmit the card information. After going through an evaluation according to a predetermined rule, the card issue server may transmit mobile card information to the personal digital assistant, and the personal digital assistant receiving the mobile card information may install the information in a storage space, such as a universal subscriber identity module (USIM) chip, an internal memory, and an external memory etc, thereby installing the mobile card in the terminal.

FIG. 18B, reproduced from the first reference, illustrates a method of issuing a mobile card. A user who wants to obtain a mobile card may bring the personal digital assistant 10 capable of NFC into contact with the NFC capable IC card 20. In case that the app for issuing a mobile card is not installed in the personal digital assistant, i.e., at the first tagging, a NFC data exchange format (NDEF) message may be solely transmitted to the personal digital assistant 10 (S415). The transmitted NDEF message may include connection information to download the card issue app or an TC card serial number. At the first tagging, since an app associated with a corresponding NFC tag is not registered in the personal digital assistant 10, the personal digital assistant 10 may display a screen to allow the user to select an app the user wants to use among NFC reader apps installed in the personal digital assistant 10. When the user selects one of the apps 51, the personal digital assistant 10 may display a record list included in the NDEF message read by using the corresponding app (S420).

The user may select a URI record 52 which is the connection information for downloading the card issue app (S430). Then, the personal digital assistant 10 may connect to a site from which the corresponding app can be downloaded (hereinafter, referred to as an app download server). The app download server may be an app store selling an app or a site providing a service according to the present invention. When the user presses an installation button 53 again, a request for downloading an app may be transmitted to the app download server (S435), and the card issue app enabling the mobile card to be issued may be transmitted to the personal digital assistant 10 from the app download server (S437).

The personal digital assistant 10 which downloaded and installed the card issue app may register a tag name format (TNF) key value (S440) which associates tag information included in the NDEF message received at step S415 with the card issue app. The TNF key value is a key value in a form of URL to select an app which can be executed upon contacting. In other words, after the TNF key value is registered, when a tag having the tag information associated with the corresponding TNF key value is contacted, an app selected by the TNF key value is executed.

After the tag value of the IC card 20 is registered in the personal digital assistant 10 through the aforementioned procedure, when bringing the corresponding IC card 20 into contact with the personal digital assistant 10 (S450), the NDEF message is transmitted to the personal digital assistant 10 (S455), like at step S415. However, since the TNF key value associated with the tag value of the IC card 20 is registered in the personal digital assistant 10, the card issue app for issuing a mobile card is executed due to the TNF key value (S460).

When the card issue app is executed, the personal digital assistant 10 may send a request for information required to issue a card (e.g., a card number, an expiration date, a card name, or user information) to the IC card 20 (S465), which may be performed according to an ISO7816 standard. Specifically, the personal, digital assistant 10 where the card issue app is executed sends a PPSE Select command to the IC card 20, and the IC card 20 transmits PPSE Response to the personal digital assistant 10 in response to the command. The personal digital assistant 10 obtains AID of the corresponding IC card from the response, and transmits a AID Select command. Then, the IC card 20 transmits AID Response including the card information to the personal digital assistant 10 in response to the command. Required information may foe displayed on a screen of the personal digital assistant 10 while reading the card information from the IC card.

Afterwards, when reading the card information required to issue a card from the IC card 20 (S467), the personal digital assistant 10 may display a screen which allows information requiring an additional input to be inputted therein (S470). The information requiring an additional input may include a card validation code (CVC) number printed on a rear surface of the credit card. In addition, authentication may be performed using one or more of a user identification number, other information, e.g., a telephone number or a telecommunicate ion company, an authentication certificate, a USIM of a cellular phone, an OTP, a card password, fingerprint recognition, ocular recognition, and voice recognition, in addition to the authentication using the CVC number.

Then, when the user inputs the CVC number for the CVC number 54 and clicks a request button 55 (S480), the card issue app extracts card application information for applying for a card from the inputted information and the information read from the IC card, which is then transmitted to the card issue server 30 (S485). When the card application information received from the personal digital assistant 10 satisfies all the requirements to issue a mobile card, the card issue server 30 may generate the mobile card and transmits the information for the mobile card to the personal digital assistant 10 (S487). In this case, a text message for authentication may be transmitted to the user's personal digital assistant 10 to conduct additional user authentication.

The personal digital assistant 10 may store the received mobile card information in a storage space, such as the USIM (universal subscriber identity module) chip, internal memory or external memory, such that the mobile card is installed in the terminal (S490) and the user checks the mobile card by clicking a card information view button on the screen of the personal digital assistant 10.

However, according to the first related art, since the mobile card is generated based on the information of an existing credit card, it is limited in its application or impossible to respond instantly on the spot. In addition, because it always requires existing credit cards, several credit cards should be issued in advance.

In addition, despite an advantage of the mobile card, a plastic card reader using a conventional magnetic strip cannot read the mobile card, thereby preventing a widespread use of the mobile card.

The second reference (Korean Patent Application No. 10-2013-0047019) discloses a method for issuing a card using NFC and art apparatus using the method. FIG. 18C is a flowchart illustrating an operation of a terminal device according to the second reference. The terminal device 10 may obtain information about a real card previously issued through near communication with the card 20 when the card 20 is approaching. Also, the terminal device 10 may verify the efficacy by reading a corresponding block of the real card through communication with the card company server 30 having a key allowing a block access, and may check various information about the Corresponding real card, such as an issue record, service details corresponding to each card, or usage information stored in the card company server 30.

Afterwards, it can be confirmed that the user is a cardholder of the real card by validating a PIN number of the corresponding real card. Alternatively, the user may import a mobile card of the company by logging into the service through the corresponding terminal device 10, thereby enabling the card company server 30 to confirm that it is the terminal device 10 of the real card holder. After the confirmation by the card company server 30 is completed, the terminal device ID may set an additional service according to a user input. The additional service may include whether reissuing the real card, whether issuing a mobile card, or such functions as setting a PIN number of the real card and a credit line thereof.

Accordingly, the terminal device 10 may perform authentication by confirming whether or not it is a real card issued by the company based on the credit information stored in the card. Based on the authentication, it may be possible that a payment function is not granted to a smart card including an IC chip that is commercially available or to a command like APDU that is standardized to a RFID Tag, thereby preventing illegal transactions or reckless issuance and improving security. Further, the card 20 is assigned with a unique serial number, i.e., unique identification (UID) and consequently, using the UID the card can manage whether or not it is issued by the card company server 30 and the issue information.

After authentication, the terminal device 10 sets additional services which will be applied to the card. The function of the additional services may be set depending on a user objective, and may preferably an exemplary embodiments include a usage count, setting a credit line, establishing restricted functions and authority of the corresponding card upon renting, and locking and unlocking functions when lost. Setting a usage count and a credit line may indicate such functions, e.g., how many times the card can be used in an application program of the terminal, how much money can be allowed for the credit line, or whether or not predetermined services can only be paid. Examples may include children, rental objectives of corporate cards, and payment or recharging for a particular service. For example, instead of the terminal device 10, payment can be made using a card 20 in which additional services are set by the terminal device 10, such as in a swimming pool or beach where it is difficult to possess the terminal device 10. In addition, according to the second related art, in the case of the rental service, it may be prevented that children pay more than a necessary amount or pay for services other than those allowed, by limiting the card to be used once for the specific rental service. In addition, for the rental service, one time authentication program for a person using the rental service, issued by the card company server 30, may be downloaded to the terminal device 10 to restrict the card to only the person using the rental service. When the real card where the rental service is previously set is brought into contact with the terminal device 10 of the person using the rental service, the original card holder is authenticated and consequently, the approval by the card company server 30 can be made. The additional service may further include locking and unlocking services. Upon detecting inappropriate use or when the card is stolen, a request for suspending the card may be sent to the card company server 30 through the terminal device 10 of the card holder.

For example, when setting the locking and unlocking services is inputted on the terminal device 10 and the real card 20 comes into contact with the terminal device 10, card identification information and additional service information may be transmitted to the card company server 30 depending on preset services, and then a corresponding result message is received through the authentication process to complete the setting. As such, the service of locking and unlocking the card 20 becomes available through the terminal device 10.

The terminal device 10 may generate a APDU command language based on the result message received form the card company server 30 and write card information in each block region of the card 20 and applet using a writing mode of the NFC. Upon completing the writing, the terminal device 10 may read the data block of the card 20 again to confirm whether the writing is adequately performed, and send the card information back to the card company server 30 to transmit the information of additional services that are set on the application program. Thus, the terminal device 10 may receive and store the additional service in a IC chip region as well of the real card which has been previously issued.

According to the second reference, it is possible to add additional services or new functions in a conventional credit card, which is further improved as compared with the first reference, thus making the credit card new. However, it is also limited to using a conventional credit card, and as the result, it is limited in its application or impossible to respond instantly on the spot.

The third reference (Japanese Patent No. 5920747) describes a method for activating a smart card. FIG. 18D is a block diagram illustrating a configuration of a main part of a system for activating a card according to the third reference, FIG. 18E is a flowchart illustrating a processing flow of a smartphone, and FIG. 18F is a flowchart illustrating a processing flow of the card.

First, when describing a system 1 for activating the card according to the third related art, as illustrated in FIG. 18D, the system 1 for activating the card is constituted by a smartphone 2 and a card 3. In the system 1 for activating the card, the card 3 functioning as a credit card or a cash card is activated by the smartphone 2 through a near-field radio communication. In other words, since the card 3 is deactivated until being activated by the smartphone 2, the user cannot use the card 3 until the card is activated.

The smartphone 2 receives card information which is information for distinguishing the card 3 from other cards and then activates the card 3 when the card information coincides with predetermined card information. In the third related art, an example of the card information may include a card number, but is not limited thereto. Alternatively, in the third related art, a terminal for activating the card is not limited to the smartphone and may he a portable terminal (a tablet, a PC, or the like) without a phone function. The smartphone 2 includes a smartphone NFC unit 21, a fingerprint sensor 22, a display unit 23, an operation accepting unit 24 and a smartphone control unit 25, as illustrated in FIG. 1D.

The smartphone NFC unit 21 is a device which performs near field communication to the card 3, more particularly, a card NFC unit 31 to foe described below. The fingerprint sensor 22 is a sensor which obtains, fingerprint information as user's fingerprint information. The display unit 23 is a device that displays images indicated by image signals output from the smartphone control unit 25. The display unit 23 is implemented according to a transmit liquid crystal panel with a backlight, an organic electro luminescence (EL) display unit, or the like. The operation accepting unit 24 is a device for accepting a user's operation and outputs operation information indicating the accepted operation. The operation accepting unit 24 is implemented by a touch sensor installed to be overlapped with the display unit 23 or the like.

The smartphone control unit 25 has a function of integrally controlling each configuration of the smartphone 2 and is implemented according to a CPU. The smartphone control unit 25 also functions as a fingerprint authentication unit 26, a card information management unit 27 (A card information reception unit and a determination unit), a card activation unit 28, and a display control unit 29, as illustrated in FIG. 18D.

The fingerprint authentication unit 26 determines whether or not the fingerprint information output from the fingerprint sensor 22 matches the previously registered fingerprint information and outputs the determination result. For example, the fingerprint authentication unit 26 can operate the smartphone 2 only to the user of the smartphone 2 by pre-registering the fingerprint information of the user of the smartphone 2 in the smartphone 2. The card information management unit 27 manages card information of one or more pre-registered cards. A process of managing card information by the card information management unit 27 will be described in detail in a flow to be described below.

The card activation unit 28 activates the card through the smartphone NFC unit 21 (indicates the card to be activated). More specifically, the card activation unit 28 transmits a signal to activate the card. The display control unit 29 outputs, to the display unit 23, an image signal representing an image displayed on the display unit 23.

The card 3 transmits the card information to the smartphone 2 and is activated when receiving an instruction to activate the card from the smartphone 2. As illustrated in FIG. 18D, the card 3 includes a card NFC unit 31, a first LCD 32a, a second LCD 32b, a third LCD 32c, a card control unit 33, a switch 36, a battery 37, and a solar panel 38.

The card NFC unit 31 is a device which performs near field communication to the smartphone 2, more particularly, the smartphone NFC unit 21. Alternatively, the card NFC unit 31 may also supply, to the battery 37, power supplied from a target device that performs RFC communication. Alternatively, when the card 3 includes a contact type communication unit instead of the card NFC unit 31 or added to the card NFC unit 31, the communication unit may supply, to the battery 37, power supplied from a terminal (for example, a payment terminal, an automated teller machine (ATM), or the like) that performs communication to the card 3 by contacting the communication unit. Therefore, the card 3 can very appropriately suppress the removal of the remaining capacity of the battery 37.

The LCD 32a to the LCD 32c (hereinafter, referred to as the LCD 32) are devices which display an image indicated by the image information output from the card control unit 33. The LCD 32 is a liquid crystal panel that can be embedded in the card 3, but is not limited to the liquid crystal panel and may be a display device that can be embedded in the card 3. The card control unit 33 integrally controls each configuration of the card 3 and is implemented according to a CPU.

The switch 36 is a device that accepts an operation for starting the card 3 from the user. The battery 37 is an embedded battery that supplies the power to the card control unit 33. The solar panel 38 is a solar cell that converts light into electric energy. The solar panel 38 supplies the converted electric energy to the LCD 32 when the card 3 is operated. Therefore, the card 3 includes the solar panel 38 to suppress the battery 37 from being consumed. Alternatively, the solar panel 38 supplies to the generated power to the battery 37 when the card 3 is not operated. Accordingly, the card 3 can very appropriately suppress the removal of the remaining capacity of the battery 37.

The card control unit 33 comprises as a card management unit 34 (a card information transmission unit, an activation instruction accepting unit, and an activation unit) and an LCD control unit 35. The card management unit 34 manages card information of the card 3. A process of managing the card information by the card management unit 34 will be described in detail in a flowchart to be described below. The LCD control unit 35 outputs, to the LCD 32, an image signal representing an image displayed on the LCD 32.

Hereinafter, a processing of the smartphone 2 will be described with reference to FIG. 18E. First, the smartphone control unit 25 accepts an instruction to operate an application for activating the card through the operation accepting unit 24 from the user to operate the application (S1). Subsequently, when the fingerprint authentication unit 26 acquires fingerprint information through the fingerprint sensor 22, the fingerprint authentication unit 26 determines whether or not the fingerprint information matches the predetermined fingerprint information and outputs the determined result to the card information management unit 27 (S2).

The card information management unit 27 determines whether or not the determined result is the determined result indicating that the fingerprint is matched (S3).

In step S3, when it is determined that ‘the fingerprint is matched’ (S3: Yes), the card information management unit 27 selects the activated card according to the operation information acquired from the user through the operation accepting unit 24 (S4). In the third reference, a case where the card information management unit 27 acquires the operation information representing the operation to select the card 3 will be described. In addition, the card information management unit 27 instructs the display control unit 29 to display a card contactable time (1 minute in the third related art). The display control unit 29 displays the card contactable time on the display unit 23 when accepting the instruction (S5). Subsequently, the card information management unit 27 determines whether the card information is received or not within 1 min which is the card contactable time (S6).

In step S6, when it is determined that ‘the card information is received within 1 min’ (S6: Yes), the card information management unit 27 determines whether or not the receive information matches the card information of the card selected in step S4 among the card information managed by the card information management unit 27 (S7). In step S7, when it is determined that ‘the card information is matched’ (S7: Yes), the card activation unit 28 designates a period (payment time) of activating the card and the number of used times (the number of payment times) of the card and activates the card 3 (S8). Herein, the payment time and the number of payment times designed by the card activation unit 28 may be preset by the user or may be a predetermined payment time arid a predetermined number of payment times.

Subsequently, the rest of the card information management unit 27 instructs the display control unit 29 to display the payment time and the number of payment times. The rest of the display control unit 29 displays the payment time and the number of payment times on the display unit 23 when accepting the instruction (S9). In addition, hereinafter, ‘the payment time and the number of payment times’ may be ‘at least one part of the payment time and the number of payment times’. In addition, the card information management unit 27 determines whether or not to acquire the operation information representing an operation to reset the payment time and the number of payment times (S10).

In step S10, when it is determined that ‘there is no request for resetting the payment time and the number of payment times’ (S10: No), the card information management unit 27 determines whether or not the payment time and the number of payment times are equal to predetermined values (S11). In step S11, when it is determined that ‘the payment time and the number of payment times are equal to the predetermined values (S11: Yes), the card information management unit 27 ends the application of activating the card (S12).

Alternatively, in step S3, when it is determined that ‘the fingerprint is not matched’ (S3: No), the card information management unit 27 determines whether or not mismatch of the fingerprint reaches the predetermined number of times (three times in the third related art) (S13). In step S13, when it is determined that ‘it is not the third time’ (S13: No), the card information management unit 27 returns to the process of step S2 and performs the fingerprint authentication again. Meanwhile, in step S13, when it is determined that ‘it is the third time’ (S13: Yes), or in step S6, when it is determined that ‘the card information is. not received within 1 min’ (S6: No), the card information management unit 27 proceeds to the process of S12 to terminate the application.

Alternatively, in step S10, when it is determined that ‘there is the request for resetting the payment time and the number of payment times’ (S10: Yes), the card information management unit 27 acquires the payment time and the number of payment times which are set according to a user's input (S14) and then returns to the process of step S5. Alternatively, in step S7, even when it is determined that ‘the card information is not matched’ (S7: No), the card information management unit 27 returns to the process of step S5.

Alternatively, in step S11, when it is determined that ‘the payment time and the number of payment times are not equal to the predetermined values (S11: No), the card information management unit 27 returns to the process of step S9.

As such, in the third reference, the smartphone 2 receives the card information from the card 3 to determine whether or not the card information matches the predetermined card information. In addition, when it is determined that the card information matches the predetermined card information, the smartphone 2 activates the card 3. As a result, the smartphone 2 may suppress power consumption of the battery 37 of the card 3 in order to remove the need for the card 3 to execute the process of determining whether or not to activate the card 3.

Alternatively, in order to activate the card 3, even if the owner loses the card 3, the smartphone 2 may prevent the card 3 from being illegally used by a third party.

Alternatively, the smartphone 2 designates a period of activating the card 3 and at least one of the number of used times of the card 3 and activates the card 3. Accordingly, in order far the user to change the period of activating the card 3 and at least one of the number of used times of the card 3 by operating the smartphone 2, the smartphone 2 may improve convenience of the user.

Hereinafter, a processing or the card 3 will be described with reference to FIG. 18F. When the card control unit 33 acquires the operation information representing the operation to operate the card 3 through the switch 36, the card 3 is operated by the power supplied by the battery 37 (S21). In addition, the LCD control unit 35 displays an image indicating the operation (a figure of “8” in the third related art) on the LCD 32 (S22). Subsequently, the card management unit 34 transmits the card information of the card 3 to the smartphone 2 through the card NFC communication unit 31 (S23).

Subsequently, when receiving the instruction to activate the card 3 from the smartphone 2, the card management unit 34 activates the card 3 (S24). More particularly, the card management unit 34 activates the card 3 when receiving a signal to activate the card. When the card 3 is activated, the LCD control unit 35 displays an image on the LCD 32 (in the third related art, displays a card number on the first LCD 32a, an expiration date on the second LCD 32b, and a security code on the third LCD 32c) (S25). In addition, the card management unit 34 determines whether or not the smartphone 2 requests resetting of the payment time and the number of payment times (S26). In other words, the card management unit 34 determines whether or not the card is activated by designating the payment time and the number of payment times again from the smartphone 2.

In step S26, when it is determined that ‘there is a request for resetting the payment time and the number of payment times’ (S26: Yes), the card management unit 34 resets the payment time and the number of payment times (S27). In addition, the card management unit 34 determines whether or not the payment time and the number of payment times are equal to predetermined values (S28).

Alternatively, even when it is determined that there is no request for resetting the payment time and the number of payment times (S26: No), the card management unit 34 executes the process of S28.

In step S28, when it is determined that the payment time and the number of payment times are equal to the predetermined values (S28: Yes), the card management unit 34 deactivates the card 3. Meanwhile, in step S28, when it is determined that the payment time and the number of payment times are not equal to the predetermined values (S28: No), the card management unit 34 returns to the process of step S25.

As such, in the third reference, the card 3 transmits the card information to the smartphone 2 to activate the card 3 when accepting the instruction to activate the card 3 from the smartphone 2. Accordingly, the card 3 may suppress power consumption of the battery 37 because the process of determining whether or not the card 3 is activated is not required. Alternatively, in order to accept the instruction to activate the card from the smartphone 2, even if the owner loses the card 3, the card 3 may be prevented from being illegally used by a third party. Alternatively, except for when the owner uses the card, the card 3 is deactivated. Therefore, the card 3 can prevent the card information from being extracted by skimming.

As such, the third reference has many advantages as compared with the first and second references. Nevertheless, in the third reference, there is inconvenience in that the card needs to be touched to the smartphone as it is for a predetermined time for operating an app of the smartphone for activating the card, pressing a button of the card, and activating the card for NFC communication between the smartphone and the card.

Generally, a communication distance of the NFC is about 10 cm, but actually, when considering the thickness of the smartphone itself and radio interference, the card needs to be kept in close contact with the smartphone, and when the smartphone is held with one hand and an object is gripped with the other hand, the keeping operation itself is not easy.

Further, while the card is activated, when the card is shaken or the communication is not smooth due to other reasons, there is a problem that the card needs to be restarted from the beginning.

The physical features of MFD cards and methods of fabricating such cards have been thoroughly disclosed elsewhere and will be briefly described here. A MFD card may include chips and antennae on a printed circuit board. An NFC chip and NFC antenna may enable the MFD card to communicate with a compatible RFC reader, such as one found on a smartphone or another personal electronic device. A Bluetooth Low Energy (BLE) chip and BLE antenna may enable the MFD card to communicate with a BLE capable device, such as a smartphone. Instead of or in addition to BLE capabilities, the MFD card may include means for another form of wireless personal area network communication. The MFD card may include a financial chip having internal memory to store card information such as a card number, expiration date, and identification information. The financial chip may be connected a contact pad to allow the MFD card to operate as a contact type smart card.

The MFD card may additionally include a battery and means to power on the MFD card, such as a power button. The MFD card may include other buttons or input means. A display and a display chip of the MFD card may allow relevant information to be displayed.

Examples of a card having multiple functions and a method for fabricating the same may be found in the fourth reference, Korean Patent Application No. 10-2015-0181146. Embodiments of the card described in the fourth reference are illustrated in FIGS. 18G-18O.

FIG. 18G is a plane view illustrating an integrated card module, FIGS. 18H and 18I are cross-sectional views illustrating an integrated card module, FIG. 18J is a view illustrating a stacking configuration of an integrated card, FIGS. 18K and 18L are a plane view and a bottom view illustrating an integrated card, respectively, FIG. 18M is another plane view illustrating an integrated card module, and FIG. 18N is another plane view illustrating an integrated card, and FIG, 18O is the other plane views illustrating an integrated card according to a preferred exemplary embodiment of the present invention.

As noted above, card information from several different cards may be loaded on the MFD card. A user may load such card information from a personal electronic device and transfer the information to the MFD card. However, the convenience of loading information from several cards on one physical card may be negated by security concerns. The loss or theft of the single card may mean the breach of personal identification or financial information from numerous cards.

One way to minimize the security risks of MFD cards is to activate the MFD card only when needed. For example, information from a card or cards may be registered on the MFD card and the MFD card then may be activated to enable use. The MFD card may send a signal to a smartphone via a NFC connection. Subsequently, the smartphone may activate the MFD card for a desired number of transactions within a designated time frame. After the MFD card has been used for the desired number of transactions and the time period for activation has passed, the MFD card becomes deactivated.

However, such reliance upon a NFC connection for activation is not ideal for general consumer use. A NFC connection requires close contact (less than 20 cm) between the transmitter and receiver. Additionally, data transfer rate through an NFC network can be quite slow compared to other wireless communication modes, which means that a user may need to hold the MFD card very close to a smartphone for an inconvenient amount of time to activate the MFD card for use.

Furthermore, such a MFD card may still be lost or stolen after being activated and used before becoming deactivated. In such a case, an NFC activation security feature would be useless.

Therefore, there is a need for a convenient method to securely activate a MFD card only by the intended user. This invention is directed to address the above problems and satisfy a long-felt need.

### SUMMARY OF THE INVENTION

The present invention contrives to solve the disadvantages and shortcomings of the prior art by providing a method for securely activating an MFD card.

In one embodiment of the invention, a method for activating a multi-function device (MFD) card 100 by a personal electronic device 300 may include: wirelessly connection to a near-field communication (NFC) network 200′; searching through the NFC network 200′ for the MFD card 100 within a communicable range of the personal electronic device 300 by transmitting NFC signal to enable electromagnetic induction in a NFC antenna 14a of the MFD card 100; launching a preloaded application for initiating MFD card 100 activation; mutually authenticating the registered MFD card 100 and the personal electronic device 300; and when the registered MFD card is authenticated, enabling the registered MFD card 100 for use.

The method may further include connecting the MFD card 100 by a wireless personal area network (WPAN) 200 using a WPAN antenna 13a and a WPAN chip 13 of the MFD card 100 upon launching the preloaded application for initiating MFD card 100 activation.

The WPAN 200 connection may be a Bluetooth Low Energy (BLE) connection enabled by a BLE antenna 13a and a BLE chip 13 of the MFD card 100.

The method may further include: after discovering the MFD card 100 within NFC range, determining whether the discovered MFD card 100 includes one or a plurality of designated applets, wherein each applet corresponds to a function of the MFD card 100; displaying on a display screen 380 of the personal electronic device 300 a list of applets available for the MFD card 100; receiving a selection from a user from an input unit 370; and launching the applet selected by the user.

The input unit 370 may be buttons or a keyboard on a touch-sensitive display screen 380, a physical keyboard, a fingerprint recognizer, a microphone, or another input device.

The method for activating the MFD card 100 by a personal electronic device 300 may include registering the MFD card 100 in a computer readable memory medium of the personal electronic device 300.

The step for registering the MFD card 100 may include: receiving a request by a user from an input unit 370; enabling a WPAN communication and searching for the deactivated MFD card 100 within a communicable range; if no MFD card 100 is discovered, performing a second search by WPAN communication; if no MFD card 100 is discovered after the second search, terminating; the card search; enabling electromagnetic induction in a WPAN antenna 13a of the discovered MFD card 100 and wirelessly connecting the personal electronic device 300 to the MFD card 100 via a WPAN connection; displaying on a display screen 380 a name for the discovered MFD card 100; displaying on the display screen 380 a password input window; and performing password authentication of an input password.

The method may further include a step for registering one or more optional settings. These optional settings may include but are not limited to selecting a username, selecting a card skin type, and selecting an additional MFD card unlock method. Unlock methods include but are not limited to a password input and a fingerprint authentication. Registering one or more optional settings may include: displaying on the display screen 380 of the personal electronic device 300 an input window to register additional settings; receiving input from a user to select the optional setting; displaying on the display screen 380 an input window to set the selected additional setting; and receiving input from the user. After an optional setting has been registered, additional optional settings may be registered by repeating the optional setting registration steps

The method for registering the MFD card may include steps of, before a request by a user is received, displaying on the display screen 380 an input window for selecting whether to add the detected MFD card 100 and receiving a selection by the user from the input unit 370.

The method may further include: pre-registering an applet for the registered MFD card 100, wherein pre-registering an applet includes displaying a card applet list on a display screen 380 and receiving a selection of an applet to be pre-registered from the user.

The step of mutually authenticating the MDF card 100 and the personal electronic device 300 may include: requesting card information stored in a financial chip 14 of the MFD card 100; determining whether card information of the MFD card 100 matches corresponding card information stored in an internal memory of the personal electronic device 300; displaying on a display screen 380 an error message if the requested card information does not match the card information stored in the personal electronic device 300; displaying on the display screen 380 an additional authentication input window if the requested card information matches the card information stored in the personal electronic device 300; receiving additional authentication information by the user from an input unit 370; determining whether the additional authentication information matches authentication information stored in the internal memory of the personal electronic device 300; displaying on the display screen 380 a second error message if the additional authentication information does not match; and completing the authentication if the additional authentication information matches.

The method may further include: changing a setting for activating the MFD card 100.

Changing a setting may include: receiving a selection by a user from the input unit 370 and performing the setting change by the main control unit 360.

Although the present invention is briefly summarized, the fuller understanding of the invention can be obtained by the following drawings, detailed description, and appended claims.

### BRIEF DESCRIPTION OF THE DRAWINGS

These and other features, aspects, and advantages of the present invention will become better understood with reference to the accompanying drawings, wherein:

FIG. 1 is a schematic illustration of a MFD card and a personal electronic device used to activate the MFD card.

FIG. 2 is a flowchart for a method of activating a MFD card according to the present invention.

FIG. 3 is a flowchart for a method of selecting an applet.

FIG. 4 is a flowchart for a method of registering a MFD card.

FIG. 5 is a flowchart for a method of selecting additional settings to activate the MFD card.

FIG. 6 is a flowchart for a method of mutual authentication of the MFD card and personal electronic device.

FIG. 7A is a flowchart for a method of changing the settings for activating a MFD card.

FIG. 7B is a flowchart for a subroutine to change the applet.

FIG. 8 is a flowchart illustrating a method of issuing a card.

FIG. 9 is a schematic view illustrating an operation of registering a possessing credit card and transmitting to a card.

FIG. 10 is a schematic view illustrating an operation of registering an issued card using a smart phone app.

FIG. 11 is a schematic view illustrating an operation of receiving a newly issued card through a smart phone and transmitting to an integrated card.

FIG. 12 is a schematic view illustrating an operation of registering other card information according to a preferred exemplary embodiment of the present invention.

FIG. 13A is an illustration of an input/output window for a procedure for registering a MFD card when there is no registered card.

FIG. 13B is an illustration of an input/output window for a procedure for registering a MFD card when there is a registered card.

FIG. 14A is an illustration of an input/output window displaying a search result for when registered cards are searched.

FIG. 14B is an illustration of an MFD card.

FIG. 14C is another illustration of an MFD card.

FIG. 15A is an illustration of an input/output window for inputting a password to authenticate an MFD card.

FIG. 15B is an illustration of an input/output window displaying a password input error message arid requesting another password input.

FIG. 15C is an illustration of an input/output window displayed when password authentication is successful.

FIG. 16 illustrates an input/output window for describing a procedure of mutual authentication of a MFD card.

FIG. 17A illustrates an input/output window for requesting use of a MFD card.

FIG. 17B illustrates a MFD card having a display with activated card information when card lock is released.

FIG. 18A is a prior art illustration of a relationship between a card, personal electronic device, internet, and a card issue server.

FIG. 18B is a prior art method of issuing a mobile card.

FIG. 18C is a prior art illustration of the operation of a terminal device.

FIG. 18D is a prior art illustration of a smartphone communicating with a card.

FIG. 18E is prior art method of activating a smart card.

FIG. 18F is a prior art method of activating a smart card.

FIG. 18G is a prior art illustration of a MFD card.

FIG. 18H is a prior art illustration of a cross-sectional view of a MFD card.

FIG. 18I is a prior art illustration of another cross-sectional view of a MFD card.

FIG. 18J is a a prior art illustration of an exploded cross-sectional view of a MFD card.

FIG. 18K is a prior art illustration of a top plan view of a MFD Card.

FIG. 18L is a prior art illustration of a bottom plan view of a MFD card.

FIG. 18M is a prior art illustration of a top plan view of a MFD card according to another embodiment.

FIG. 18N is a prior art illustration of a top plan view of a MFD card according to another embodiment.

FIG. 18O is a prior art illustration of a top plan view of a MFD card according to another embodiment.

### DETAILED DESCRIPTION OF THE EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations by use of the word “about”, it will be understood that the particular value forms another embodiment.

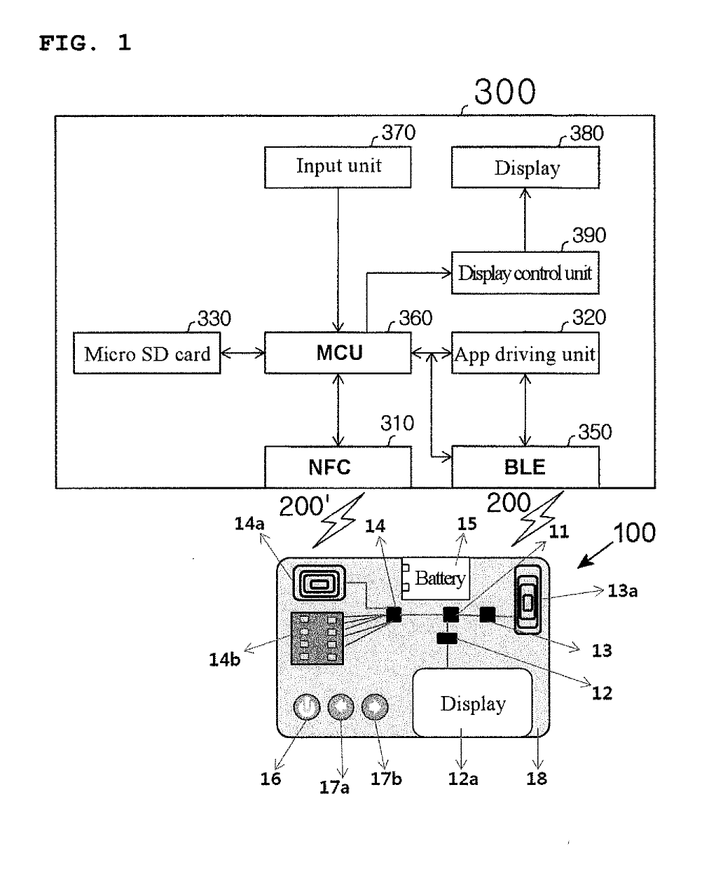

As shown in FIG. 1, the multi-function device (MFD) card 100 to be activated may include a printed circuit board (PCB) 18 having a main control unit (MCU) 11 connected to one or several chips.

One chip that may be electrically connected to the MCU 11 may be a display chip 12, which may be connected to and control a display 12a of the MFD card 100. The display 12a may be used to display card information such as card number, expiration date, and identification information.

FIG. 1 also shows a financial chip 14, which is connected to a near-field communication (NFC) antenna 14a and a contact pad 14b. The financial chip 14 may have internal memory wherein information for various cards may be stored. The NFC antenna 14a may enable the MFC card 100 to communicate with a NFC reader via a NFC network 200′. The contact pad 14b may enable the MFD card 100 in a contact mode.

The MCU 11 may also be connected to a wireless personal area network (WPAN) chip 13, which may be connected to a WPAN antenna 13a. The WPAN chip 13 and WPAN antenna 13a may enable WPAN communication of the MFD card 100. As shown in FIG. 1, the WPAN connection may be a Bluetooth Low Energy (BLE) network connection.

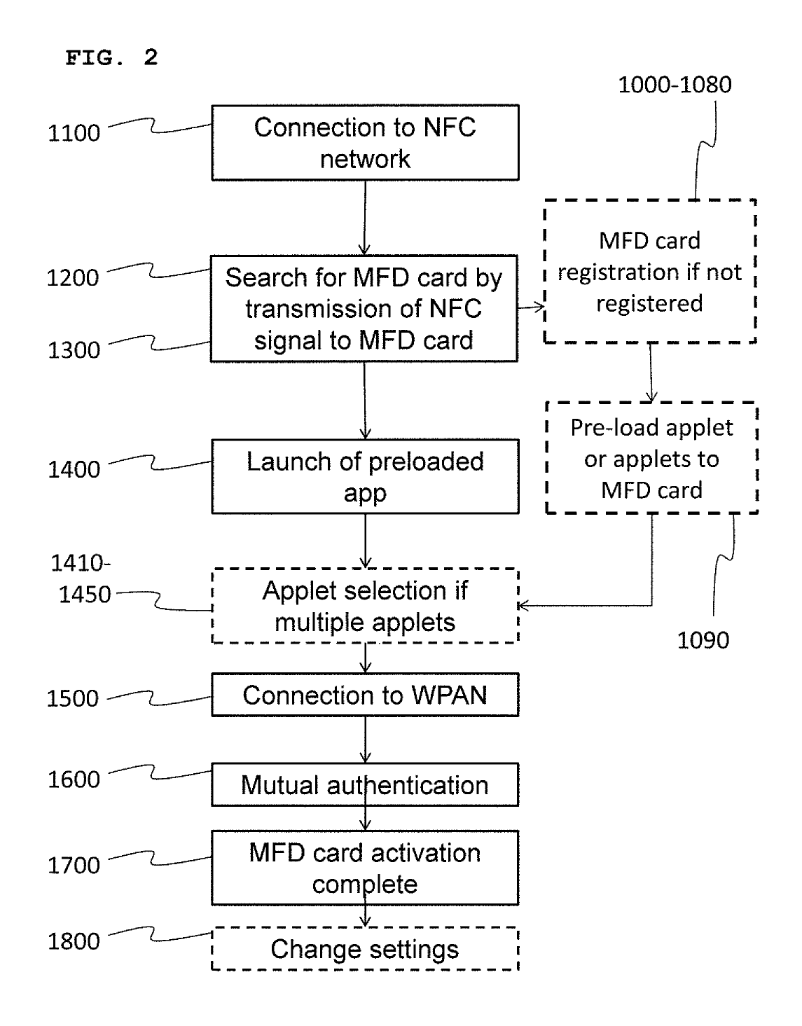

According to the present invention, the MFD card 100 may be activated by the method illustrated in the flowchart of FIG. 2. The method may include: first, connecting 1100 a personal electronic device 300 to a NFC network 200′; searching 1200 for a MFD card 100 by transmitting 1300 by the personal electronic device 300 NFC signal to the MFD card 100; launching 1400 a preloaded application, on the personal electronic device; connecting 1500 the personal electronic device 300 to a wireless personal area network (WPAN) 200; and mutually authenticating 1600 the MFD card 100 and the personal electronic device 300. The steps shown in boxes with broken line outlines may be optional steps included in some embodiments of the present invention.

The WPAN 200 connection may be a BLE connection, as shown in FIG. 1.

According to the embodiment of the present invention as illustrated in FIG. 2, the method for activating the MFD card 100 may include a step of selecting an applet if multiple applets are loaded on the MFD card 100. An applet may correspond to a function of the MFD card 100 including but not limited to: a financial payment card, such as a credit card, a debit card, or a gift card; an identification card, such as one issued by a local, state, or national government or one issued by a school or employer; or a transportation ticket or pass. Multiple applets may be loaded on the MFD card 100; the method of the present invention activates one of the applets so that the MFD card 100 may be used as a card corresponding to a selected applet.

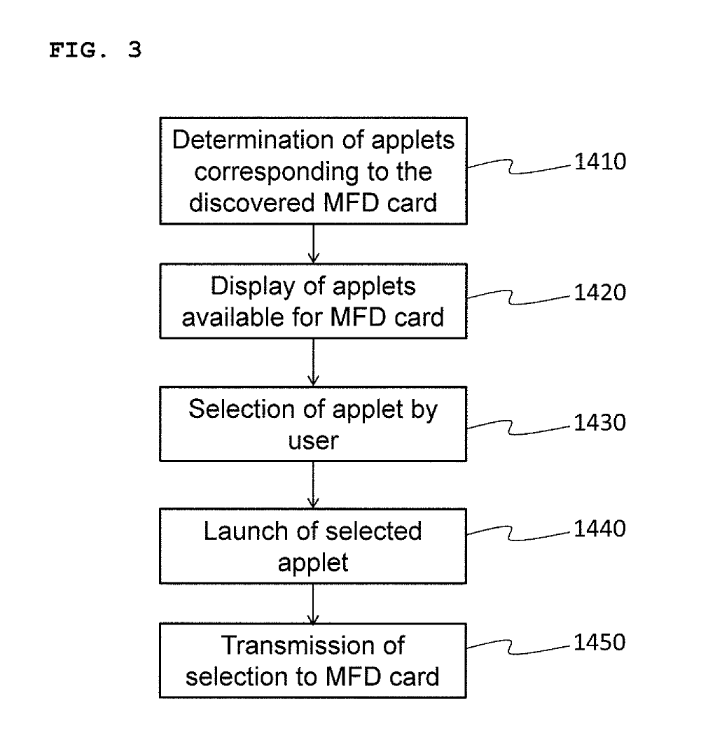

When multiple applets are preloaded onto a MFD card 100, the method of selecting an applet to be used is illustrated in the flowchart of FIG. 3 and may include: determining 1510 by the personal electronic device 300 the applets corresponding to the discovered MFD card 100; displaying 1520 by the personal electronic device 300 an input unit to select an applet from the applets available with the MFD card 100; selecting 1530 an applet by the user on the input unit of the personal electronic device 300; launching 1540 the selected applet on the personal electronic device; and transmitting 1550 the selection to the MFD card 100 through the NFC network 200′.

In other embodiments, the personal electronic device 300 may connect to the WPAN 200 (such as a BLE network) before the applet selecting step. In such a case, the applet selection may be transferred from the MFD card 100 to the personal electronic device 300 through the WPAN 200.

In case a MFD card 100 is not registered, the card may be registered by a user according to the method illustrated in FIG. 4. Such a method may include: receiving 1000 by the personal electronic device 300 an input request from a user; enabling 1010 WPAN communication on the personal electronic device; searching 1020 for the MFD card 100 over the WPAN 200; if the MFD card 100 is not discovered, searching again 1022 for the MFD card 100; if the MFD card 100 is not discovered after the second search 1022, the search may be terminated 1024; if the MFD card 100 is discovered, the personal electronic device and the MFD card may establish 1040 a WPAN connection; a name of the discovered MFD card 100 may be displayed 1050 on a display screen 380 of the personal electronic device 300; the card may be authenticated 1060 by a password input by the user; in some embodiments, additional MFD card settings may foe registered 1070 before the MFD card registration is complete 1080.

After the MFD card has been registered, an applet or applets may be pre-loaded 1090 on the MFD card, as shown in FIG. 2.

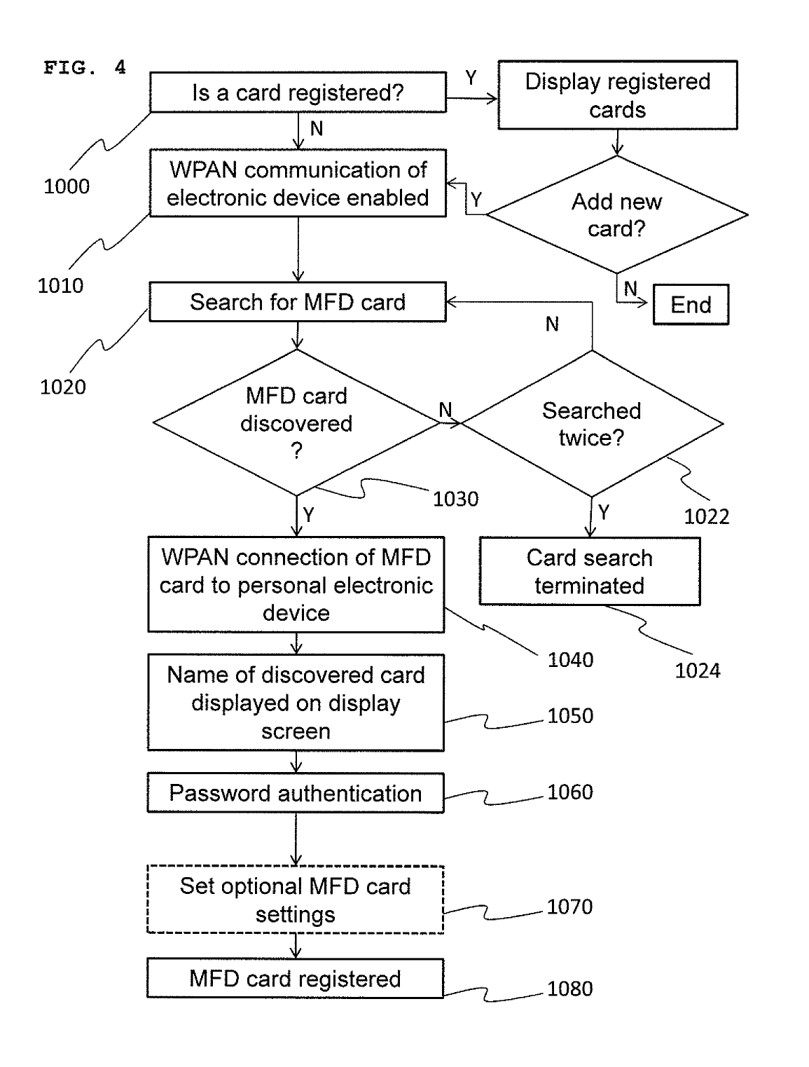

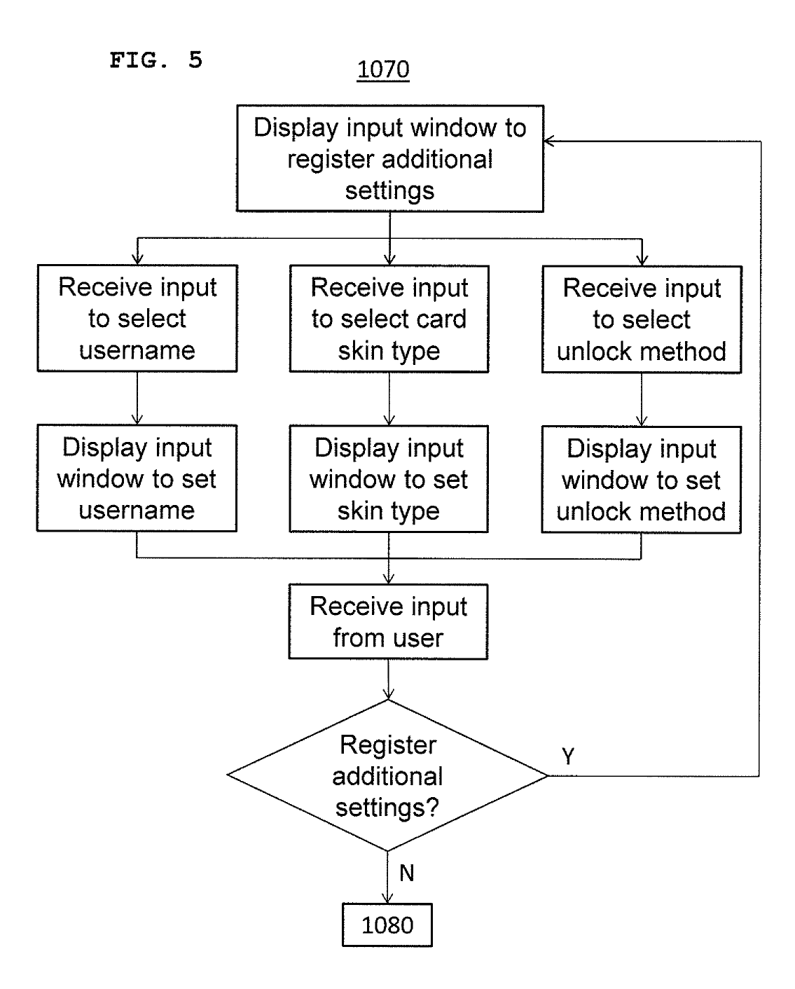

As shown in FIG. 5, such additional MFD card settings may include but are not limited to: selecting a username, setting a skin type for displaying the MFD card 100 , and setting an MFD card unlock method. Additional unlocking methods may include but are not limited to fingerprint authentication, facial recognition, and voice recognition. As shown in FIG. 5, registering additional settings may include displaying an input window to register additional settings, receiving input to select an additional setting, displaying an input window, and receiving an input from the user.

The step of inputting a request 1000 from the user may include displaying on. the display screen 380 an input window for selecting whether to add a new MFD card 100 and receiving a selection by the user from the input unit 370.

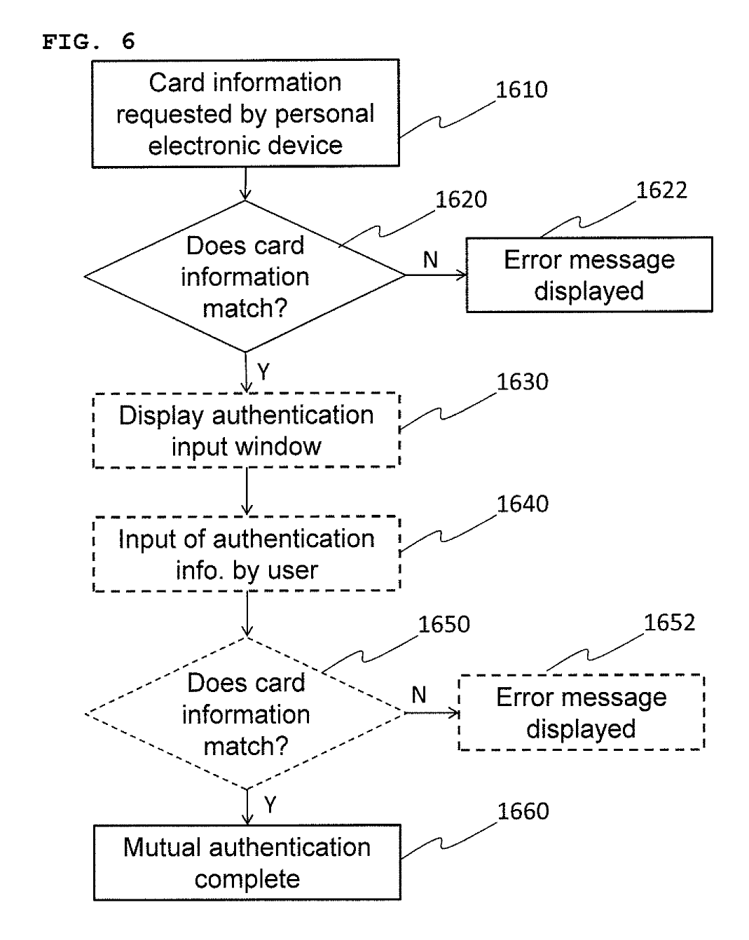

FIG. 6 illustrates the steps of mutually authenticating 1600 the MFD card 100 and the personal electronic device 300, which may include: card information being requested 1610 by the personal electronic device 300 through the WPAN 200 connection; determining 1620 by the personal electronic device whether card information of the MFD card matches corresponding card information stored in a computer readable memory medium; displaying 1622 on a display screen 380 an error message if the requested card information does not match the card information stored in the personal electronic device 300; displaying 1630 on the display screen 380 an additional authentication input window if the requested card information matches the card information stored in the personal electronic device 300; inputting 1640 additional authentication information by the user into the input unit 370; determining 1650 by the personal electronic device 300 whether the additional authentication information matches authentication information stored in the computer readable memory medium of the personal electronic device 300; displaying 1652 on the display screen 380 a second error message if the additional authentication information does not match; and completing 1660 the authentication if the additional authentication information matches. The steps of FIG. 6 shown in boxes with broken line outlines may be optional steps that may not be necessary for mutual authentication 1600.

Card information may include but is not limited to card number, expiration date, and identification information. The card information may be stored in a financial chip 14 of the MFD card. Corresponding card information may be stored in a computer readable memory medium of the personal electronic device 300. The computer readable memory medium may include but is not limited to a micro SD card 330.

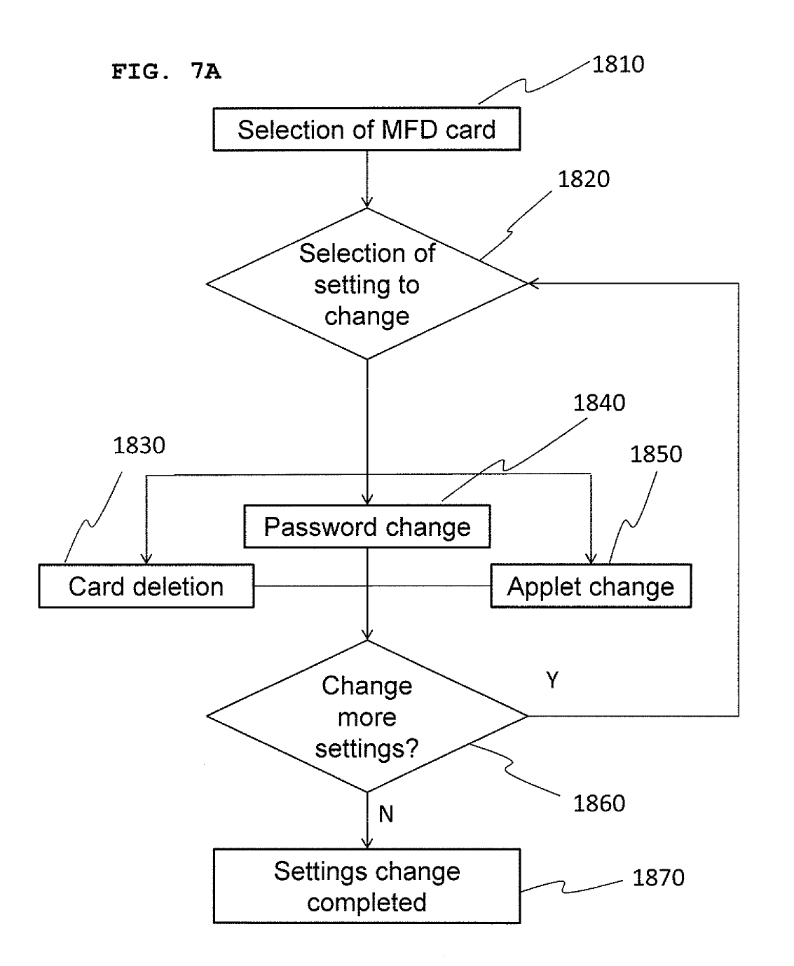

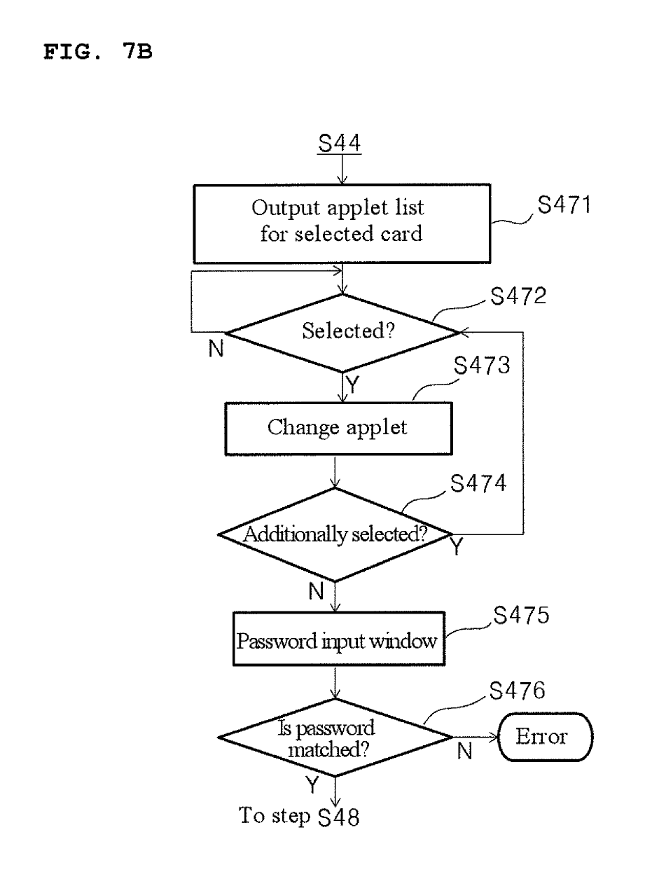

The method for activating the MFD card 100 may further include the step of changing 1800 settings, the details of which are illustrated in the flowchart of FIG. 7A. The user may first select 1810 on an input window of the personal electronic device 300 the MFD card 100 to change settings for. Settings to change may include, but are not limited to, card deletion, password change, or an applet change. The user may select a setting to change, change the setting, and then optionally choose more settings to change.

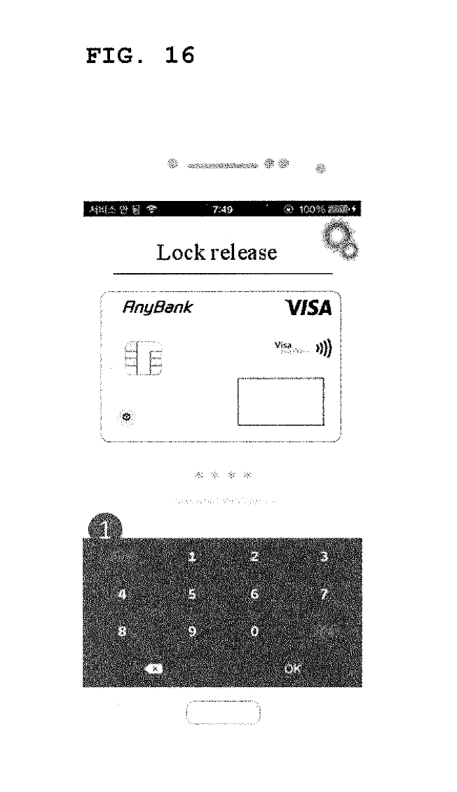

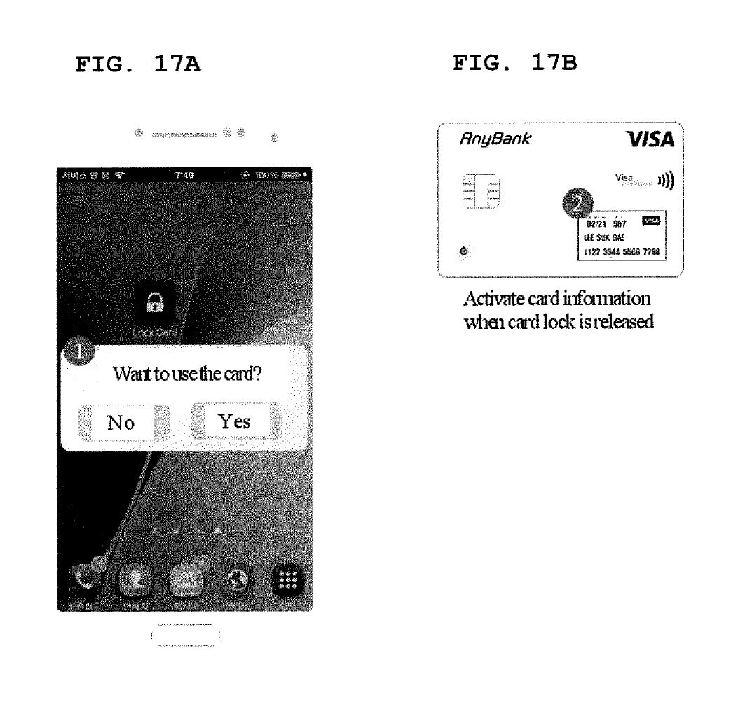

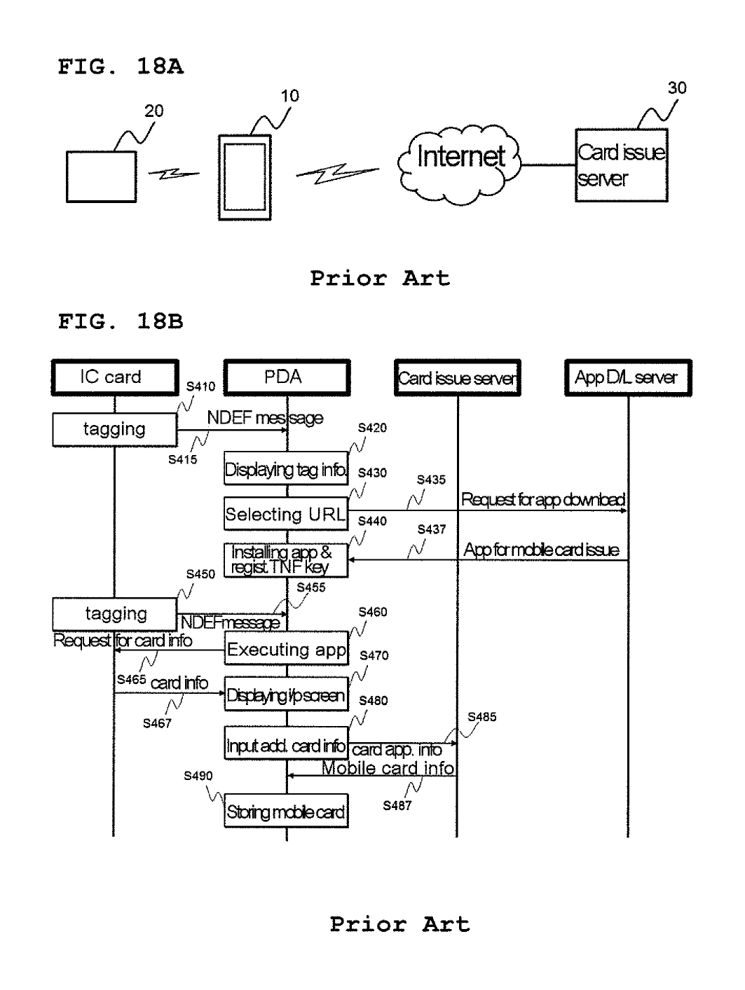

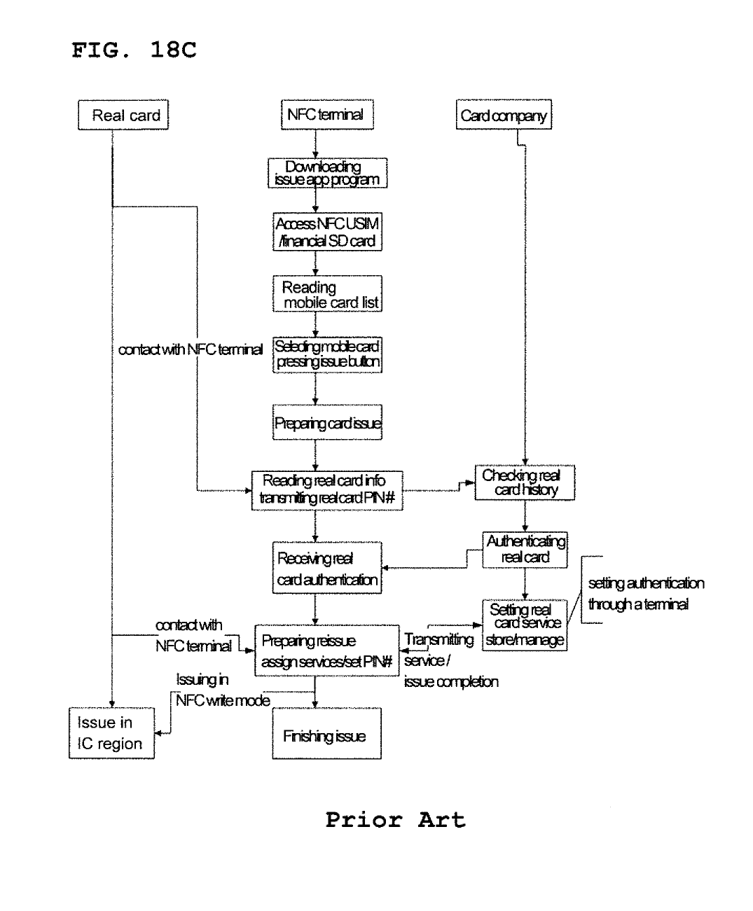

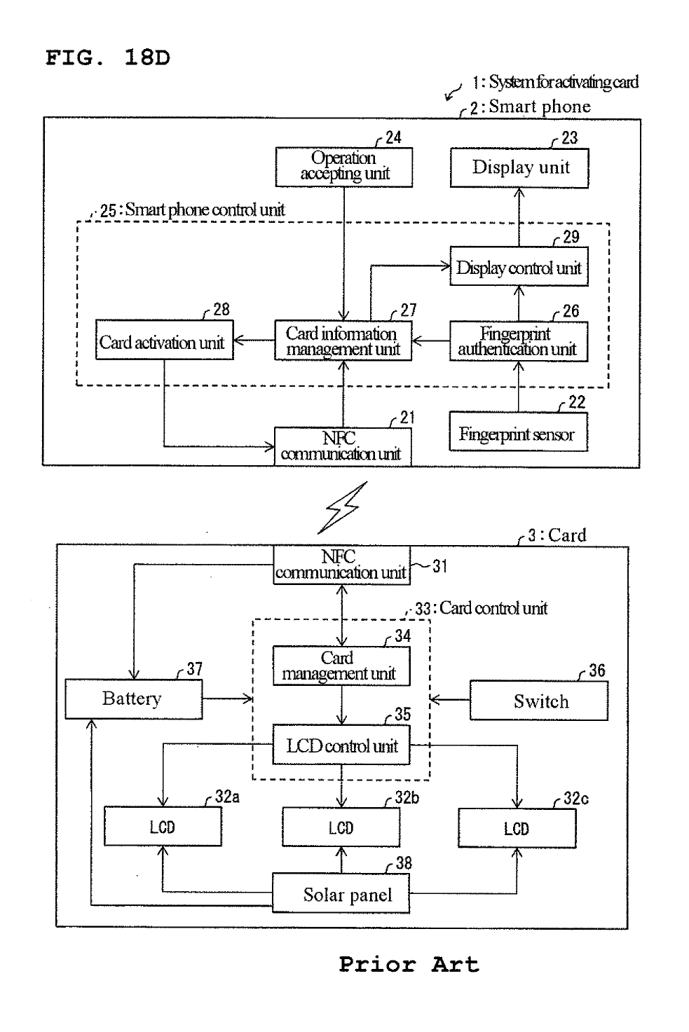

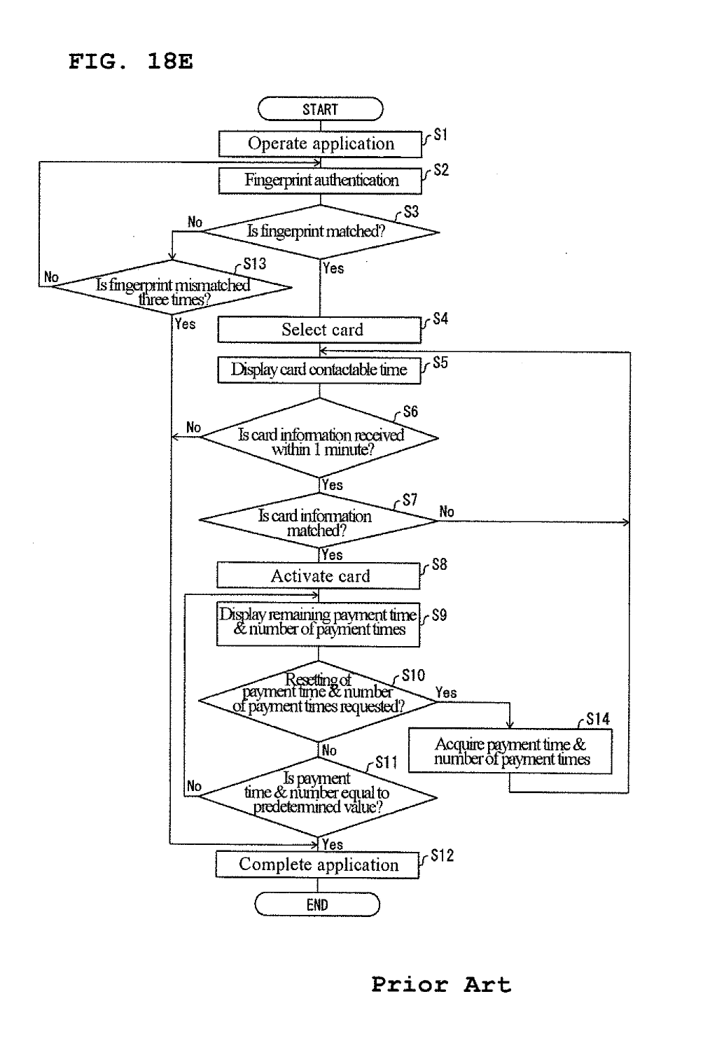

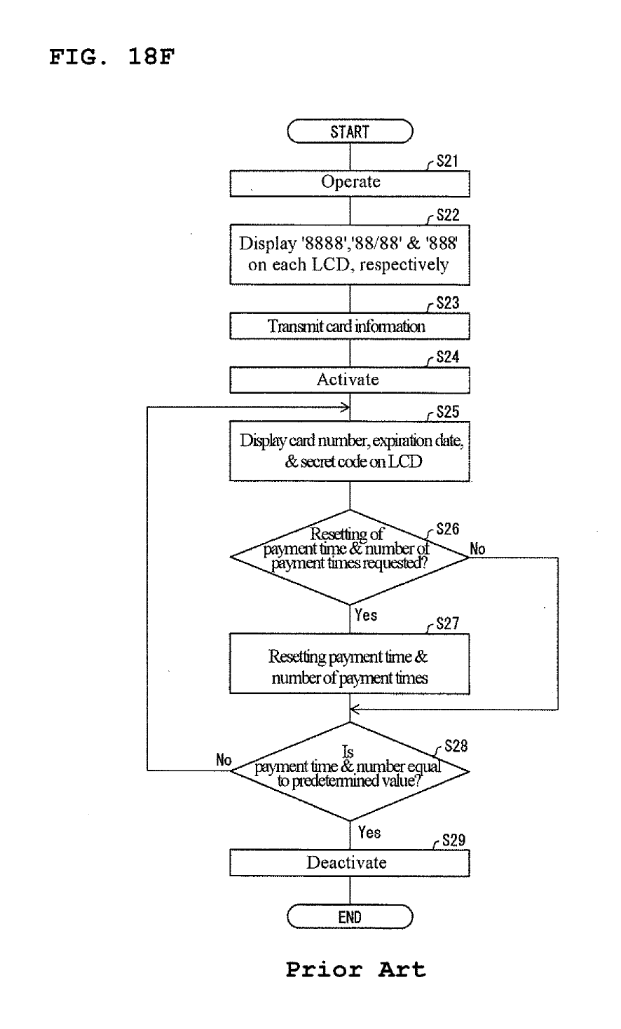

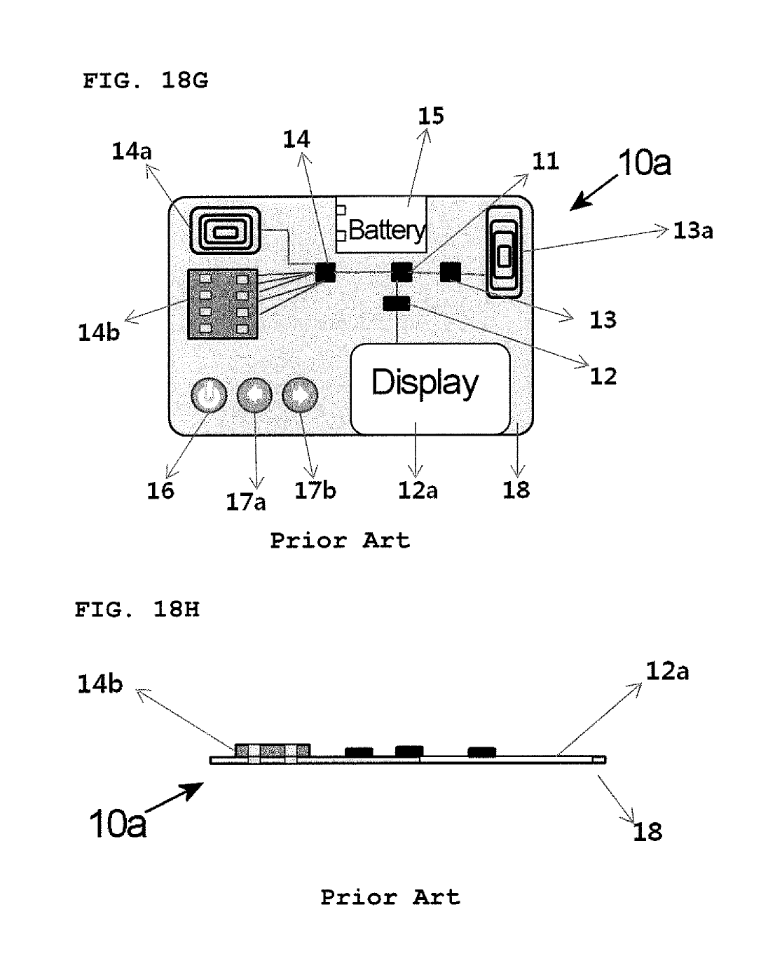

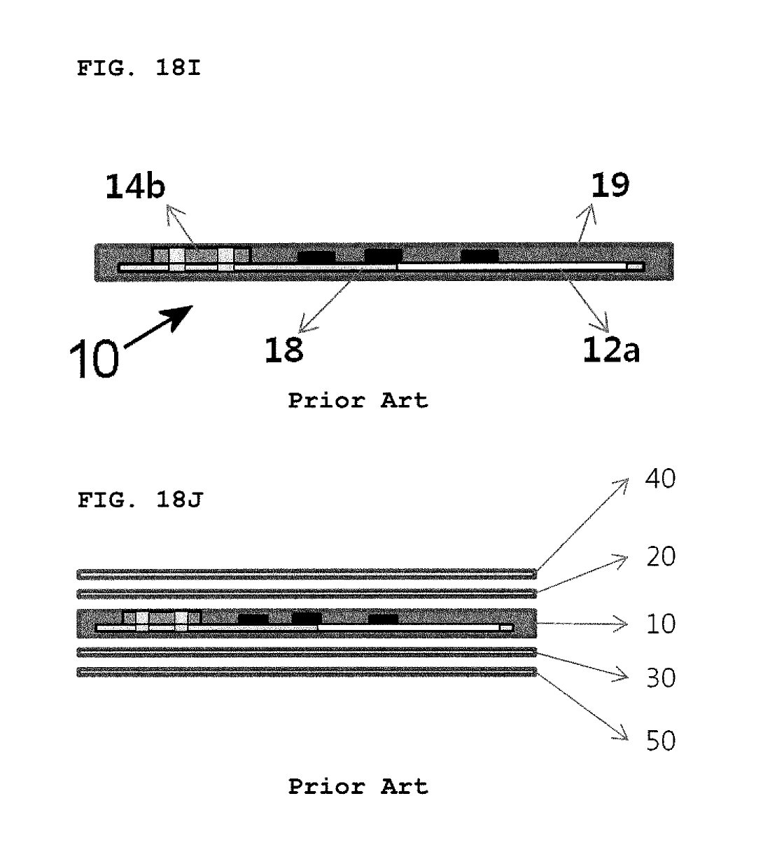

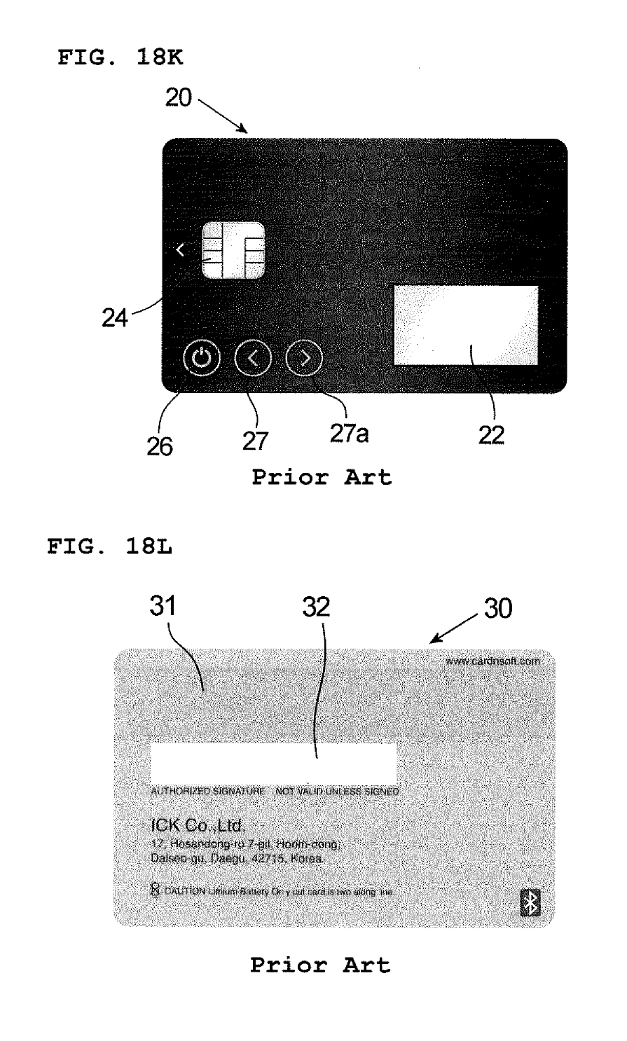

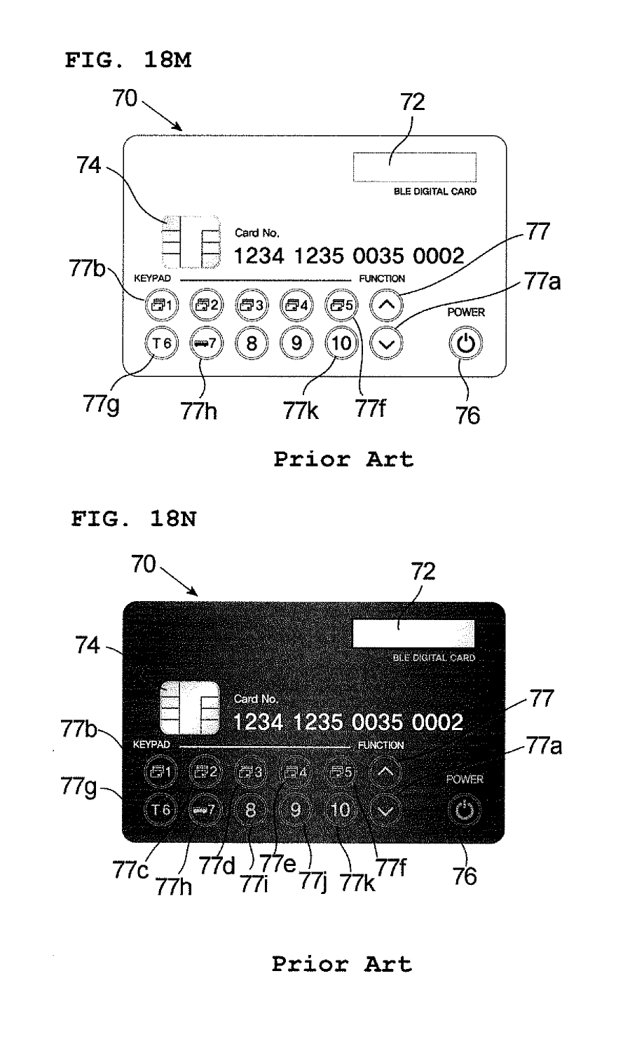

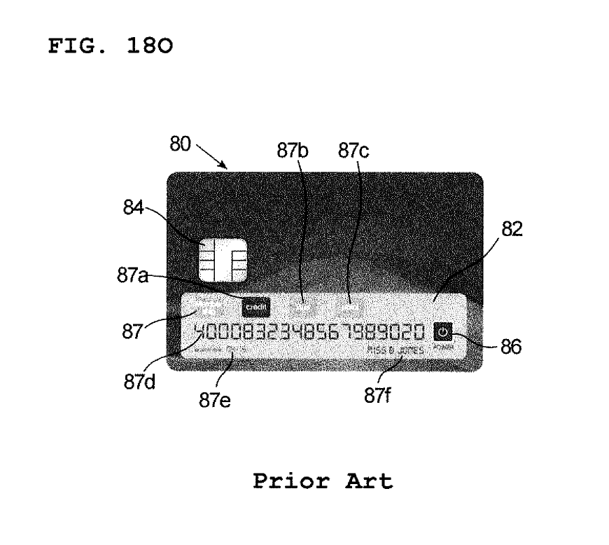

However, in the case of an applet change, since there is no general setting change procedure, the “applet change” subroutine S47 will be described in detail with reference to FIG. 17B. First, the registered applet list for the card selected in step S43 is output S471, the applet change is performed S473 with respect to the applet selected by the user S472, and after it is determined whether an additional applet change is desired S474, if the additional applet change is desired, the process returns to step S472 and is repeated and if there is no additional selection, in order to verify the password for authentication according to the setting change, the password input window is displayed S475, and after it is determined whether the password input from the user matches the pre-stored password S476, if not matched, the error is output and if matched

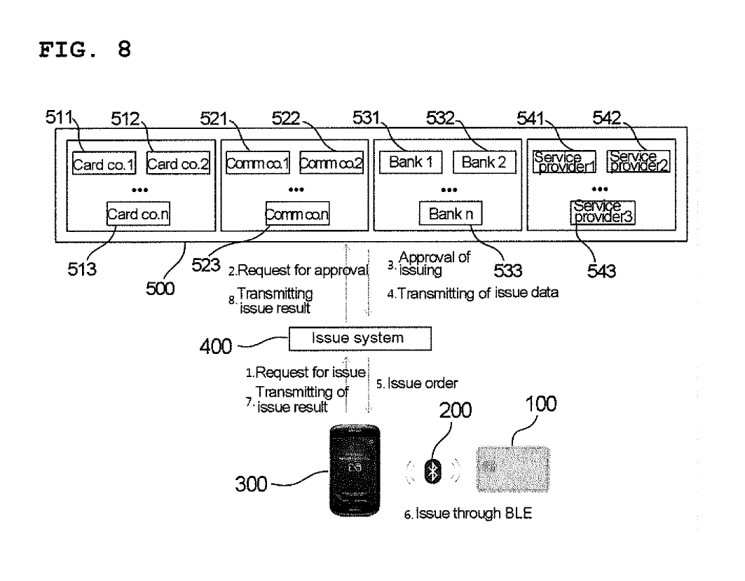

Hereinafter, a method of issuing an integrated card according to a preferred exemplary embodiment of the present, invention will be described with reference to FIGS. 8 to 12.

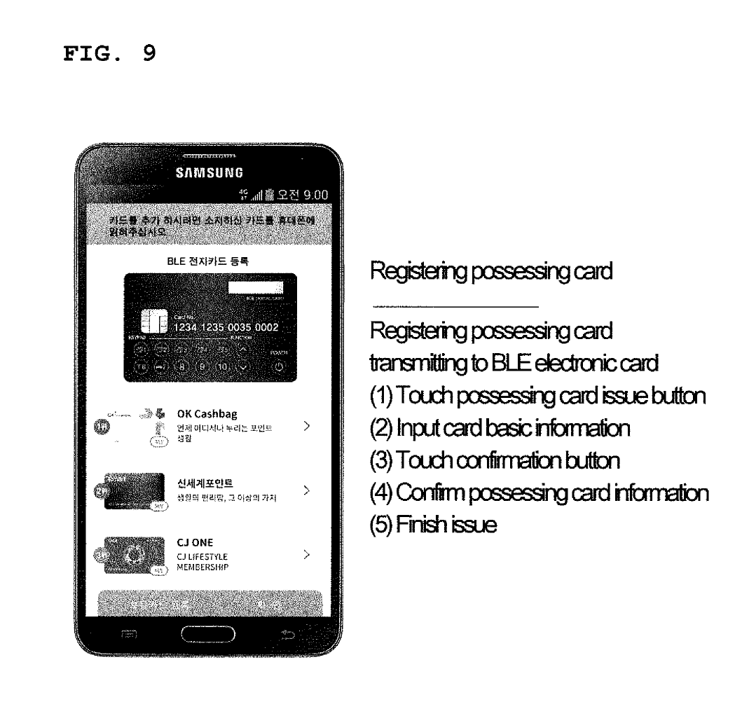

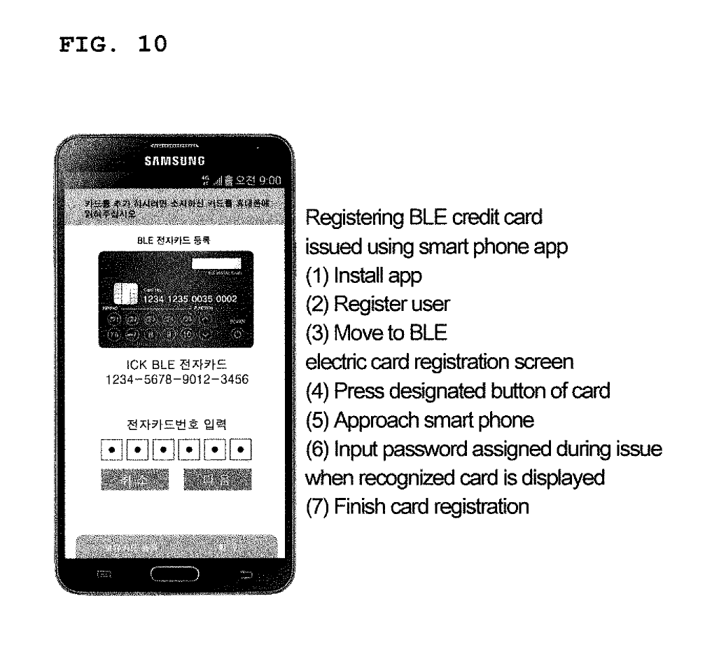

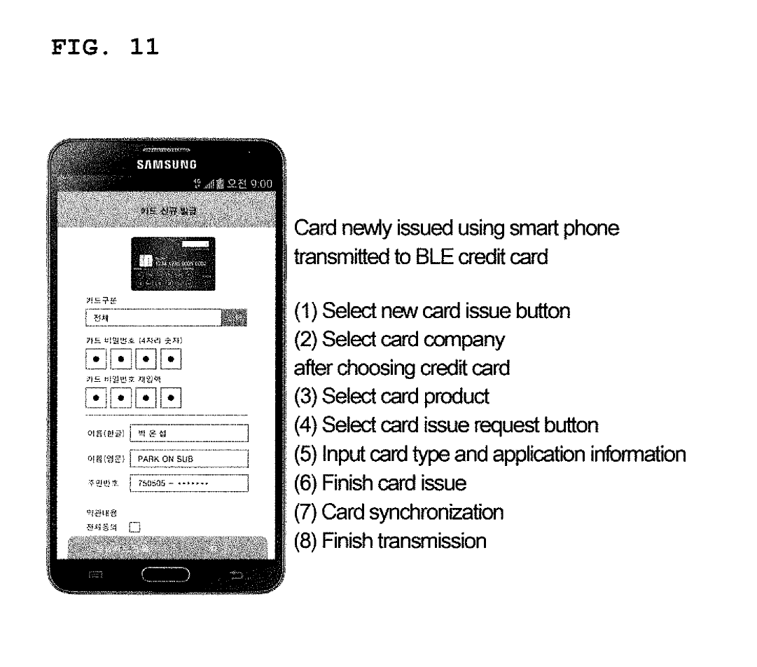

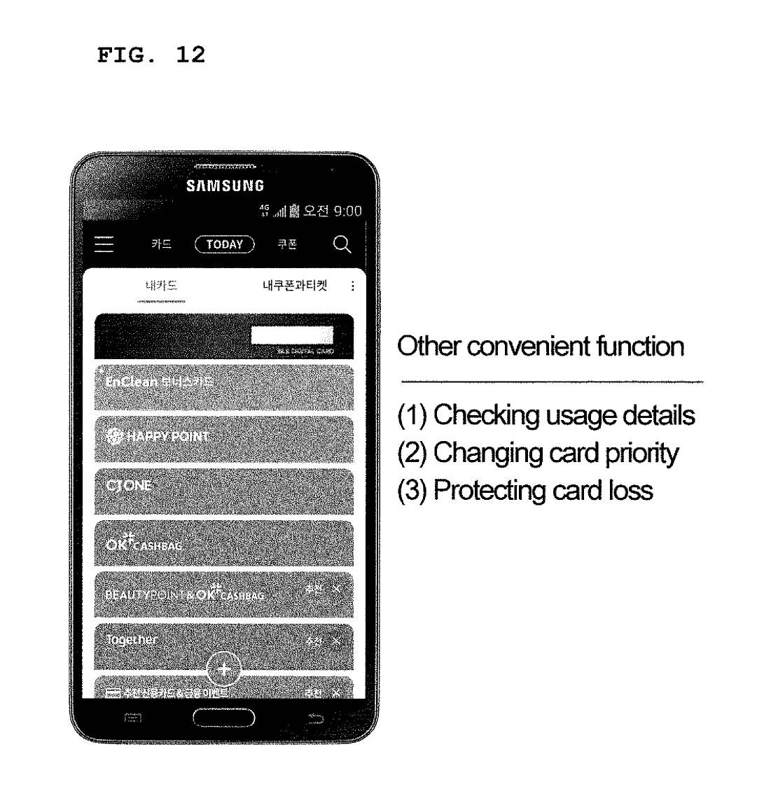

FIG. 8 is a flowchart illustrating a method of issuing an integrated card, FIG. 9 is a schematic view illustrating an operation of registering a possessing credit card and transmitting to an integrated card, FIG. 10 is a schematic view illustrating an operation of registering an issued card using a smart phone app, FIG. 11 is a schematic view illustrating an operation of receiving a newly issued card through a smart phone and transmitting to an integrated card, and FIG. 12 is a schematic view illustrating an operation of registering other card information according to a preferred exemplary embodiment of the present invention.

A method of registering possessing two or more cards into one physical integrated card 100 will be described with reference to FIGS. 8 and 9. The personal electronic device 300 , e.g., a smart phone, is synchronized with the integrated card 100 through a WPAN such as a Bluetooth network 200, and a card currently possessed in the personal electronic device 300 is imported (this information may be integrated to a issue system server 400 or may be collected from each of the card companies by a separate app) to choose a card that needs to be integrated and click a registration button. Then, a user may be authenticated by entering basic information regarding the corresponding card and then press a confirmation button. The possessing card is then registered while confirming the card information.

Accordingly, the information for two or more cards is stored in the integrated card 100 and a user presses a power button and chooses a card to perform payment.

Next, an operation of registering a card issued using a smart phone app will be described with reference to FIGS. 8 and 10.

The operation may include installing the smart phone app in the personal electronic device 300 which may be achieved in a general way through communication with an app download server that is not illustrated herein, registering a user, moving to a screen for BLE electric card registration, and pressing a button assigned for the card that needs to be integrated.

Next, the personal electronic device 300 may come into contact with the integrated card 100 to perform synchronization through the Bluetooth network 200, and when the recognized card is displayed, the card integration may be completed through an authentication procedure, such as by entering a password assigned during issuing the card.

Finally, an operation of receiving a newly issued card through the personal electronic device 300 and transmitting it to the integrated card to integrate the card will be described with reference to FIGS. 8 and 11.

According to an embodiment of the present invention, an issue system provider server 400 has already been built such that the issue system provider server 400 exchanges information with a card issuer server 500 based on a predetermined contract, where the card issuer server 500 collectively identifies card company servers 511,512 and 513 for issuing credit cards, communication company servers 611,612 and 613 for issuing point saving cards, bank servers 711,712 and 713 for issuing debit cards, and service provider servers 811,812 and 813 for issuing membership cards.

It may be possible that the personal electronic device 300 communicates with card company servers (c)r bank servers using a separate app. However, because of complicated authentication procedures as well as un-uniform procedures for issuing a new card, it is difficult for the personal electronic device 300 to communicate with the servers individually.

For example, if a specific card issued by a “company A” is subject to 50% discount in an amusement park, when the user possesses the integrated card, the user may be issued with the corresponding discount card in the integrated card and use it.

First, the user may log into the issue system 400 on the personal electronic device 300 and clicks a new card issue button. Then, a credit card outputted on an output window is chosen, which is followed by choosing a card company for issuing the card. Here, the choosing of the credit card and the card company may be performed in a reverse order or simultaneously. Next, a card product is chosen again, which may be performed by one click.

Then, the card issue button is clicked, and when a card type and an application information are input, the card is issued. Specifically, the personal electronic device 300 sends a request for issuing a card to the issue system 400 and the issue system 400 sends a request for approval of issuing basic information (e.g., a card holder name) to a corresponding card issuer server 500. When the card issuer server 500 transmits issue data (e.g., a card number, expiry date, or CVC code) with the issue approval to the issue system 400, the issue system 400 sends an issue order to the personal electronic device 300 of the user. Then, the personal electronic device 300 performs synchronization with the integrated card 100 through the Bluetooth network 200 and completes an issue of the card through the BLE.

Simultaneously, the personal electronic device 300 transmits a card issue result to the issue system 400 and the issue system 400 transmits it to the card issuer server 500.

In this case, at least one credit card has been preferably issued in the integrated card 100 of the user in an offline mode. When the personal electronic device 300 sends a request for issuing a card to the issue system 400, it may transmit the information of a previously issued card together with the request. In this regard, the user may be waived from the credit assessment for the different card which has a same or lower credit level than the previously issued card.

Finally, FIG. 12 is a schematic view illustrating an operation of registering other convenient functions. The other convenient functions may include a function of changing additional services, a function of preventing loss, such as by alarming, when the card is moving away from the personal electronic device 300, a function of changing the priority to be activated when several kinds of cards are integrated into the integrated card, or a function of checking the usage details of each card.

In the above description, a process of integrating a plurality of cards into one physical multiple digital card 100 is expressed by various terms, but as a result, expressed by registering existing cards as one multiple digital card, being newly issued the cards and registering the issued cards as the multiple digital card, and in any case, renewing the multiple digital card and in this specification, issuing the multiple digital card.

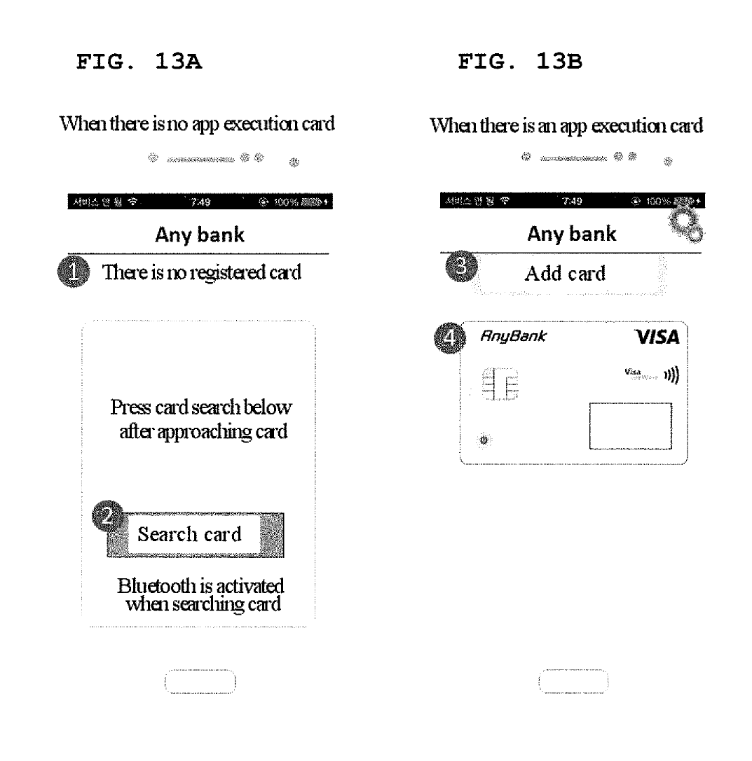

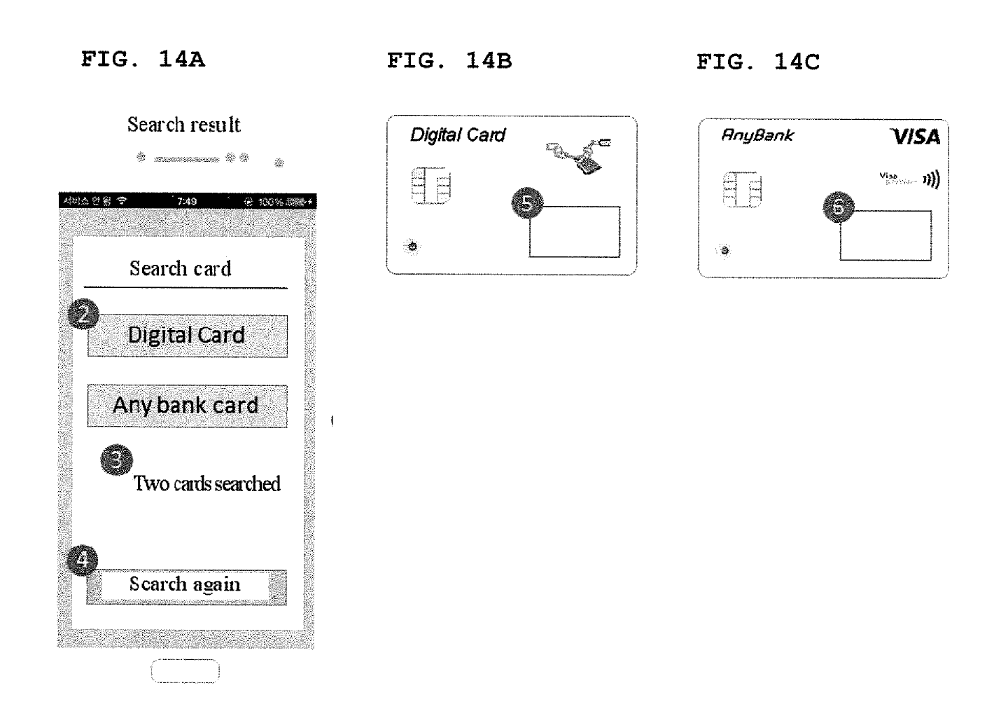

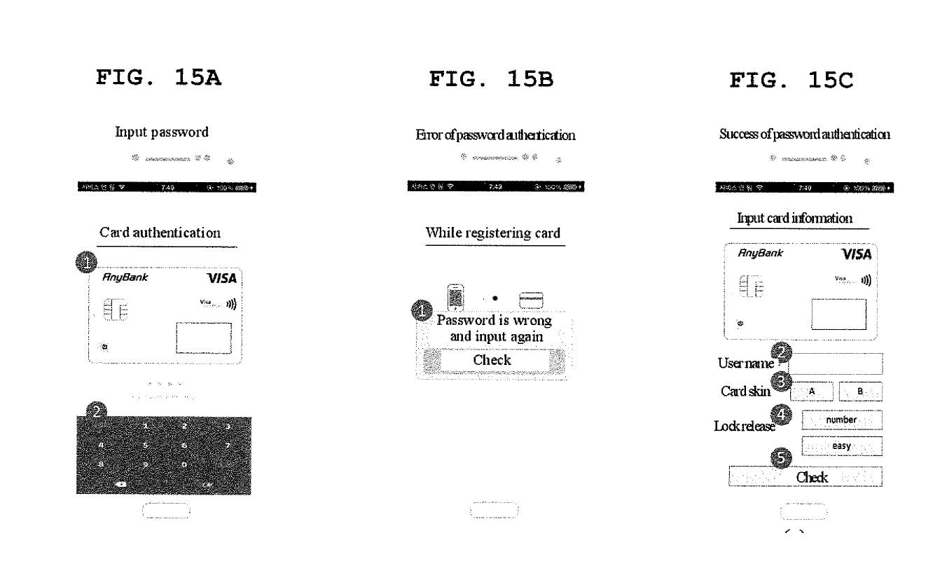

FIGS. 13-15 depict an exemplary input/output window for describing a procedure of newly registering the card as described above and illustrated in FIG. 4. FIGS. 16 and 17 depict an exemplary input/output window for describing a procedure of mutual authentication of the card of FIG. 6.

While the invention has been shown and described with reference to different embodiments thereof, it will be appreciated by those skilled in the art that variations in form, detail, compositions and operation may be made. without departing from the spirit and scope of the invention as defined by the accompanying claims.

What is claimed is:

1. A method for activating a multi-function device (MFD) card (100) by a personal electronic device (300) comprising:
switching on a near-field communication (NFC) chip (310) of the personal electronic device (300) to enable the personal electronic device (300) to wirelessly connect to the MFD card (100) via a NFC network (200′);
searching with the personal electronic device (300) in the NFC network (200′) for the MFD card (100) within a communicable range of the personal electronic device (300) by transmitting NFC signal from the personal electronic device to the MFD card to enable electromagnetic induction in a NFC antenna (14a) of the MFD card (100);
launching on the personal electronic device (300) a preloaded application for initiating MFD card (100) activation if the MFD card (100) is discovered via the NFC network (200′);
connecting the personal electronic device (300) to the MFD card (100) by a wireless personal area network (WPAN) using a WPAN antenna (13a) and WPAN chip (13) of the MFD card (100) upon launching the preloaded application for initiating MFD card (100) activation on the personal electronic device (300);
mutually authenticating the MFD card (100) and the personal electronic device (300) through the WPAN by a predetermined method by the application; and
when the MFD card (100) is authenticated, completing activation of the MFD card (100) for use.

2. The method of claim 1, wherein the WPAN connection is a Bluetooth Low Energy (BLE) connection enabled by a BLE antenna (13a) and a BLE chip (13) of the MFD card (100) and corresponding BLE antenna and BLE chip of the personal electronic device (300).

3. The method of claim 1 further comprising:
after discovering the MFD card (100) within NFC range, determining by the personal electronic device (300) whether the discovered MFD card (100) includes one or a plurality of designated applets, wherein each applet corresponds to a function of the MFD card (100);
displaying on a display screen (380) of the personal electronic device (300) a list of applets available for the MFD card (100);
inputting a selection by a user into an input unit (370); and
launching on the personal electronic device (300) the applet selected by the user.

4. The method of claim 1 further comprising registering the MFD card (100) in a computer readable memory medium of the personal electronic device (300).

5. The method of claim 4, wherein registering the MFD card (100) comprises:
receiving a request by a user from an input unit (370) of the personal electronic device (300);
enabling a WPAN communication of the personal electronic device (300) and searching for the MFD card (100) within a communicable range;
if no MFD card (100) is discovered by the personal electronic device (300), performing a second search by WPAN communication;
if no MFD card (100) is discovered after the second search by the personal electronic device (300), terminating the card search;
wireless connecting by the personal electronic device (300) to the MFD card (100) via WPAN communication by emitting WPAN signal to enable electromagnetic induction in a WPAN antenna (13a) of the discovered MFD card (100);
displaying on a display screen (380) of the personal electronic device (300) a name for the discovered MFD card (100);
displaying on the display screen (380) a password input window; and
authenticating by the personal electronic device (300) a password input by the user.

6. The method of claim 5 further comprising;
registering optional MFD card settings having the steps of:
displaying on the display screen (380) an input window to register additional settings;
receiving input from a user to select a username;
displaying on the display screen (380) an input window to set username; and
receiving input from the user.

7. The method of claim 5 further comprising:
registering optional MFD card settings having the steps of:
displaying on the display screen (380) an input window to register additional settings;
receiving input from a user to select a card skin type;
displaying on the display screen (380) an input window to set card skin type; and
receiving input from the user.

8. The method of claim 5 further comprising:
registering optional MFD card settings having the steps of:
displaying on the display screen (380) an input window to register additional settings;
receiving input from a user to select an additional unlock method;
displaying on the display screen (380) an input window to set an additional unlock method; and
receiving input from the user.

9. The method of claim 5 further comprising:
if no MFD cards are registered on the personal electronic device (300), registering the detected MFD card (100);
if multiple MFD cards are registered, displaying registered MFD cards and,
after displaying registered MFD cards, requesting input from the user to register the MFD card (100) detected by NFC.
before a request by a user is received, displaying on the display screen (380) an input window for selecting whether to add a new MFD card (100) and
receiving a selection fay the user from the input unit (370).

10. The method of claim 4 further comprising:
pre-loading an applet for the registered MFD card (100) by the personal electronic device (300),
wherein pre-loading an applet comprises displaying a card applet list on a display screen (380) and receiving a selection of an applet to be pre-loaded from the user.

11. The method of claim 1, wherein mutually authenticating the MDF card (100) and the personal electronic device (300) comprises:
requesting card information stored, in a financial chip (14) of the MFD card (100) by the personal electronic device (300);
determining by the personal electronic device (300) whether card information of the MFD card (100) matches corresponding card information stored in a computer readable memory medium of the personal electronic device (300);
displaying on a display screen (380) an error message if the requested card information does not match the card information stored in the personal electronic device (300);
displaying on the display screen (380) an additional authentication input window if the requested card information matches the card information stored in the personal electronic device (300);
inputting additional authentication information by the user into an input unit (370);
determining by the personal electronic device (300) whether the additional authentication information matches authentication information stored in the computer readable memory medium of the personal electronic device (300);
displaying on the display screen (380) a second error message if the additional authentication information does not match; and
completing the authentication if the additional authentication information matches by the personal electronic device (300).

12. The method of claim 1 further comprising:
changing a setting for activating the MFD card (100).

13. The method of claim 12, wherein changing a setting comprises:
displaying setting selections on a display screen of the personal electronic device (300);
receiving a selection by a user from the input unit (370); and
performing the setting change by the main control unit (360).
